(19) United States
(12) Patent Application Publication
(10) Pub. No.: US 2015/0321512 A1
(43) Pub. Date: Nov. 12, 2015

(54) WHEEL SYSTEMS AND METHODS

(71) Applicant: Samuel EASTON, Perth, Western Australia (AU)

(72) Inventor: SAMUEL ROBERT EASTON, PERTH (AU)

(21) Appl. No.: 14/412,852

(22) PCT Filed: Jul. 4, 2013
(86) PCT No.: PCT/AU2013/000740

§ 371 Date: Jan. 5, 2015

(30) Foreign Application Priority Data
Jul. 4, 2012 (AU) 2012902853

(51) Int. Cl. B60B 33/06; B60B 33/00

(52) U.S. Cl. CPC B60B 33/06; B60B 33/0039; B60B 2200/45

(57) ABSTRACT

In one preferred form there is provided a wheel system. The wheel system is mounted to a suitcase. The wheel system provides an extension mechanism and a wheel assembly. The extension mechanism adapted for moving the wheel assembly from a retracted condition to an extended condition. In the extended condition, the wheel assembly provides for rolling transport that is able to accommodate various obstacles and terrain.

### FIELD OF THE INVENTION

In preferred forms the present invention relates to wheel systems and methods for luggage and other carriers.

### BACKGROUND TO THE INVENTION

A number of wheel assemblies have been developed to address the problem of transporting luggage to and from various locations.

In the luggage industry most suitcases are fitted with two or more roller wheels for transport purposes. Such roller wheels are typically inbuilt into the frame of the suitcase and protrude slightly therefrom. This is generally done to minimize cost and weight as detailed in U.S. Pat. No. 6,076,641 to Paul Kinzer et al. U.S. Pat. No. 6,076,641 discloses a large wheeled luggage case of a particular form.

Whilst a background to the invention has been provided, it is to be recognised that any discussion in the present specification is intended to explain the context of the invention. It is not to be taken as an admission that the material formed part of the prior art base or relevant general knowledge in any particular country or region.

### SUMMARY OF THE INVENTION

According to a first aspect of preferred embodiments herein described there is provided a wheel system for luggage or other carriers, the wheel system comprising: an extension mechanism and a wheel assembly, the extension mechanism for moving the wheel assembly from a retracted condition to an extended condition wherein, in the extended condition, the wheel assembly provides for rolling transport that is able to accommodate various obstacles and terrain.

Preferably the wheel assembly includes at least one large wheel, each large wheel being at least 4 inches in diameter, and the extension mechanism being adapted to facilitate rotation of the wheel assembly by at least 70 degrees, from the retracted condition to the extended condition to dispose each large wheel in a rolling position providing for rolling transport accommodating grass and other relatively rough terrain as well as rolling transport up stairs.

Preferably in the extended condition the axis of each large wheel is disposed beneath the wheel system in comparison to when the wheel system is in the retracted condition.

Preferably when each large wheel is in the rolling position the wheel is disposed so as to extend horizontally across and vertically down, when the carrier is in a substantially upright position to be pulled up a step by a person.

Preferably each large wheel is associated with a secondary wheel in spaced apart relationship from the large wheel, each large wheel and the associated secondary wheel forming a wheel pair.

Preferably each secondary wheel of a wheel pair is of a smaller diameter in comparison to the associated large wheel.

Preferably in the retracted condition each secondary wheel is disposed in a position suitable for rolling along a relatively flat horizontal surface, with each associated large wheel being disposed in an inoperative rolling position thereabove.

Preferably in the extended position the wheel assembly can be pulled by the action of a person so as to roll on each large wheel with the associated secondary wheel being raised in the air.

Preferably in the extended condition the wheel assembly can be pulled down stairs such that when each large wheel rolls over the edge of a step of the stairs, the associated secondary wheel moves downwardly to contact the upper surface of the step so as to arrest the fall of the wheel assembly by contact with the upper surface of the step before each large wheel contacts the upper surface of the following step.

Preferably there are two wheel pairs in the wheel assembly that allow the wheel assembly to be stably rested in an upright condition and be pushed on the ground so as to roll on each of the wheels of the two wheel pairs.

Preferably in each wheel pair the large wheel and the associated secondary wheel are arranged so that the wheels lie in the same rolling plane and the periphery of the wheels are in close proximity.

Preferably the wheel assembly provides a pivot about which the extension mechanism is adapted to facilitate the rotation of the wheel assembly.

Preferably in each wheel pair a pivot is positioned such that when the wheel assembly is in the retracted condition and upright, the axis of the associated large wheel is horizontally disposed between the pivot and the axis of the associated secondary wheel.

Preferably the pivot is positioned such that when the wheel system is in the retracted condition and upright, the pivot is vertically disposed beneath the axis of the large wheel.

Preferably the wheel assembly is pivoted about a pivot and the distance from the pivot to each large wheel is greater than the radius of each large wheel.

Preferably the extension mechanism includes a locking mechanism for selectively locking the wheel assembly in any one of a series of extended conditions.

Preferably each extended condition is associated with a different centre of gravity allowing the wheel assembly to be rolled with different loadings.

According to a second aspect of preferred embodiments herein described there is provided a carrier system including: a frame, an extension mechanism and a wheel assembly; the extension mechanism and wheel assembly being mounted to the frame; the extension mechanism for moving the wheel assembly from a retracted condition to an extended condition wherein, in the extended condition, the wheel assembly provides for rolling transport accommodating various obstacles and terrain.

Preferably the wheel assembly includes at least one large wheel, each large wheel being at least 4 inches in diameter, the extension mechanism being adapted to facilitate rotation of the wheel assembly to move each large wheel downwardly so as lift the frame a distance of at least the large wheel radius.

Preferably each large wheel is spaced from an associated secondary wheel, each large wheel and the associated secondary wheel being rotatable about a pivot to the extended condition of the wheel assembly in which each large wheel and the associated secondary wheel is able to contact the ground to lift and stably hold the frame thereabove without the assistance of a person.

Preferably the diameter of each large wheel is at least 50 percent larger the diameter of the associated secondary wheel. Preferably the diameter of each large wheel is at least twice the diameter of the associated secondary wheel. Preferably the diameter of each large wheel is at least four times the diameter of the associated secondary wheel.

Preferably the frame can be tilted and pulled to lift each secondary wheel into the air such that the frame is supported above the ground by each large wheel.

Preferably each large wheel is disposed so as to overlie the sides of the lower end of the frame and is of a diameter at least 50% of the width of the sides so as to span substantially across the sides of the frame.

Preferably each large wheel is of a diameter at least 80% of the width of the sides of the frame.

Preferably the frame includes two lower recesses for accommodating respective large wheels when the wheels assembly is in the retracted condition.

According to a third aspect of preferred embodiments herein described there is provided a carrier system having a number of assemblies of a large wheel and a small wheel; each assembly being rotatable from a retracted condition to at least one extended condition wherein in the retracted condition the carrier system can be wheeled on the small wheel and in an extended position the carrier system can be wheeled on both the small wheel and the large wheel or only on the large wheel, as desired.

Preferably carrier system comprises a suitcase and in the extended position the large wheel provides superior foot clearance and is able to accommodate rolling transport up stairs.

Embodiments of the present invention herein described preferably provide systems and methods including:
Luggage that is able to be readily transported up and down stairs as well as over various other obstacles and terrain;
(ii) Luggage that is able to be placed in various conditions allowing the luggage to be readily pushed or pulled including conditions allowing for advantageous foot clearance;
(iii) Luggage that provides for advantageous rolling resistance and high clearance of obstacles;
(iv) Luggage that accommodates or otherwise allows further luggage to be hung or connected thereto during transport; and
(v) Luggage that is relatively robust and which can be readily repaired when damage occurs.

It is to be recognised that other aspects, preferred forms and advantages of the present invention will be apparent from the present specification including the detailed description, drawings and claims.

The present invention is to be construed beneficially to the applicant.

### BRIEF DESCRIPTION OF DRAWINGS

In order to facilitate a better understanding of the present invention, several preferred embodiments will now be described with reference to the accompanying in which

FIGS. 1 to 22 comprise views of a carrier according to a first preferred embodiment of the present invention;

FIGS. 23 and 24 comprise views of a wheel mount according to second preferred embodiment of the present invention;

FIGS. 25 and 26 comprise views of the embodiment shown in FIGS. 1 to 22;

FIGS. 26 and 27 comprise views of the embodiment shown in FIGS. 23 and 24;

FIGS. 28 to 31 show how the embodiment shown in FIGS. 1 to 22 is used in various circumstances;

FIGS. 32 and 33 provide two further views of the carrier embodiment in FIGS. 1 to 22;

FIGS. 34 to 50 illustrate another preferred embodiment of the present invention;

FIGS. 51 to 64 provide further views of the embodiment shown in FIGS. 34 to 52

FIGS. 65 and 66 illustrate another preferred embodiment of the present invention;

### DETAILED DESCRIPTION OF THE EMBODIMENTS

It is to be appreciated that each of the embodiments is specifically described and that the present invention is not to be construed as being limited to any specific feature or element of any one of the embodiments. Neither is the present invention to be construed as being limited to any feature of a number of the embodiments or variations described in relation to the embodiments.

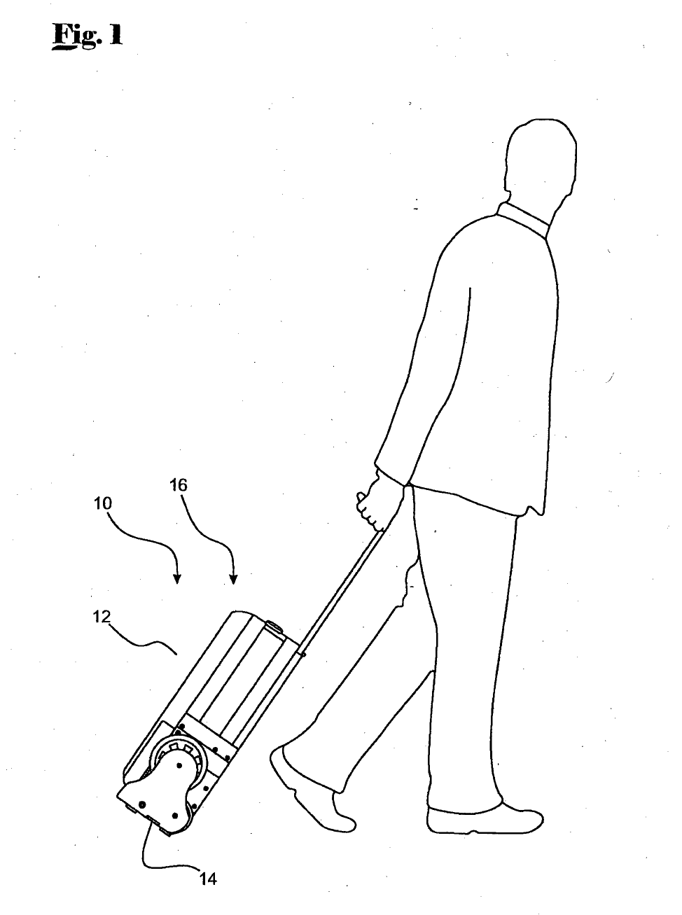

Referring to FIG. 1 there is shown a carrier 10 according to a first preferred embodiment of the present invention. The carrier 10 is provided in the form of a carry on suitcase 12 for airplane travel. The carry on suitcase 12 includes a wheel system 14 that is advantageously configurable in a number of conditions 16 as shown in FIGS. 1 to 3. The carrier 10 is advantageously adapted to assist with overcoming stairs as well as various other obstacles and terrain.

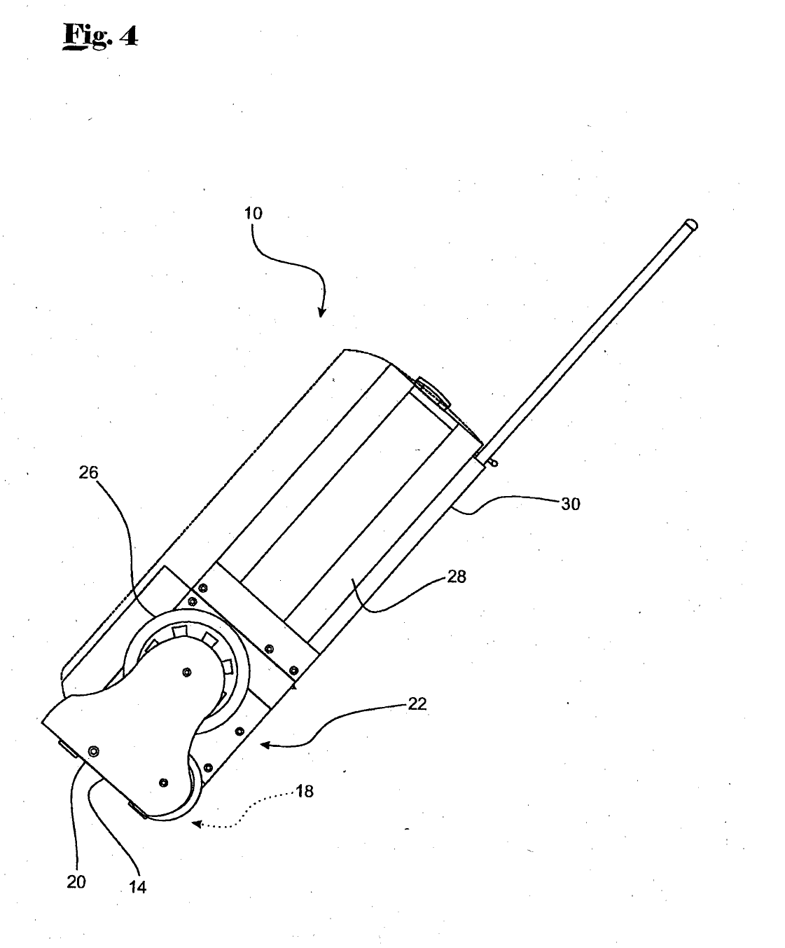

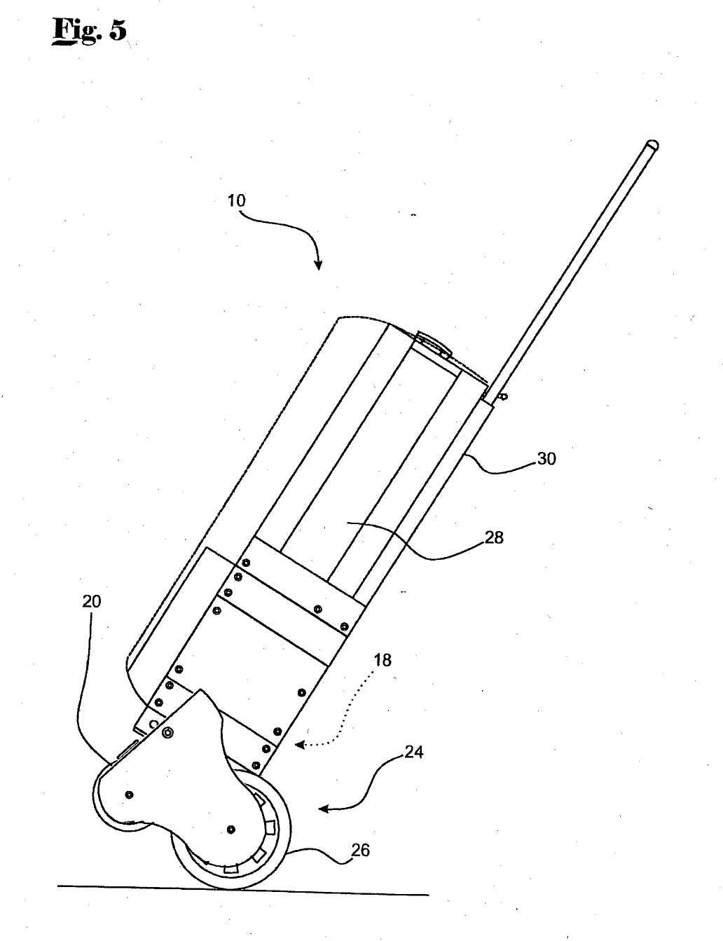

Referring to FIG. 4, the carrier 10 includes an extension mechanism 18 and a wheel assembly 20. The extension mechanism 18 is provided for moving the wheel assembly 20 from a retracted condition 22 (shown in FIG. 4) to an extended condition 24 (shown in FIG. 5). In the extended condition 24, the wheel assembly 20 provides for rolling transport. In particular, in the extended condition 24, the carrier 10 can be readily wheeled up and down stairs.

As shown in FIGS. 4 and 5, the wheel assembly 20 includes two large wheels 26, mounted on either side 28 of a solid frame 30. Although only one side is shown, the carrier is symmetrical and the other side is identical for relevant purposes.

Each large wheel 26 is much larger than a conventional suitcase wheel. In the embodiment, each large wheel 26 is about 5 inches in diameter. This advantageously provides for lower rolling resistance in comparison to a conventional suitcase wheel.

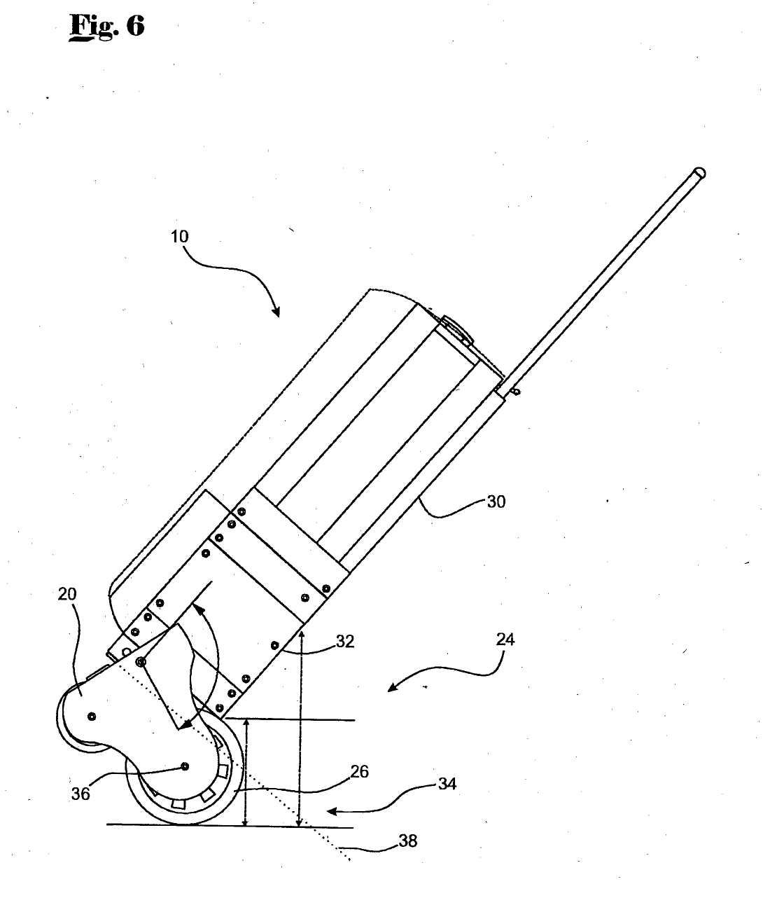

As shown in FIG. 6, the extension mechanism 18 is adapted to facilitate rotation of the wheel assembly 20 by an angle 32 of over 90 degrees from the retracted condition 22 to the extended condition 24. In the extended condition 24 each large wheel 26 is disposed in a rolling position 34 corresponding with the extended condition 24. Due to the angle 32, the axis 36 of each large wheel 26 is disposed beneath the line 38. The line 38 corresponds with the bottom of the wheel assembly 20 when the wheel assembly 20 is in the retracted condition 22.

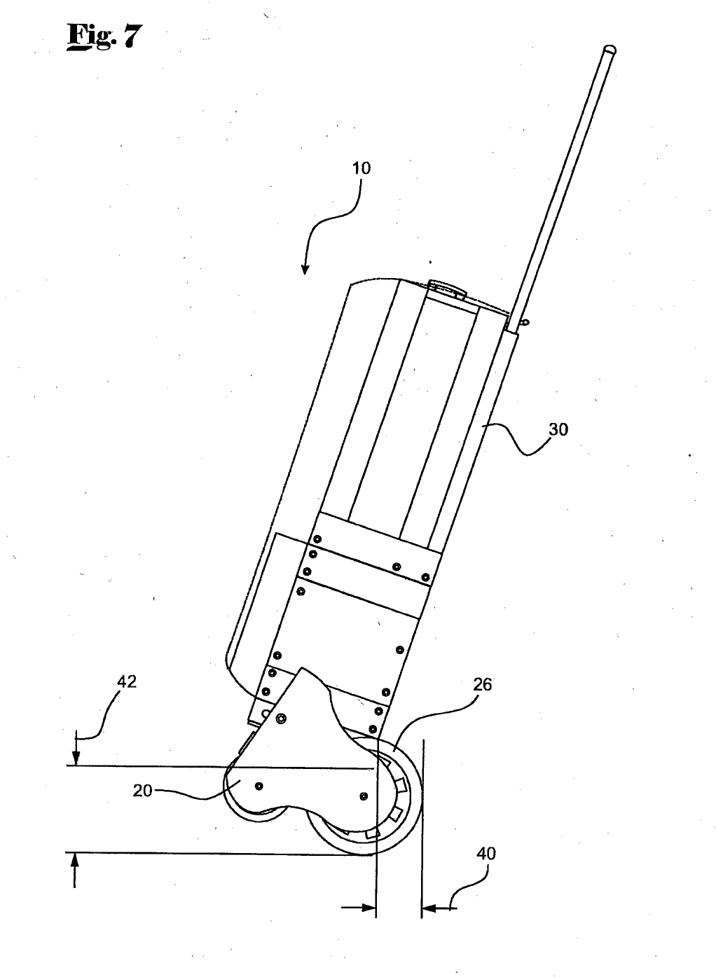

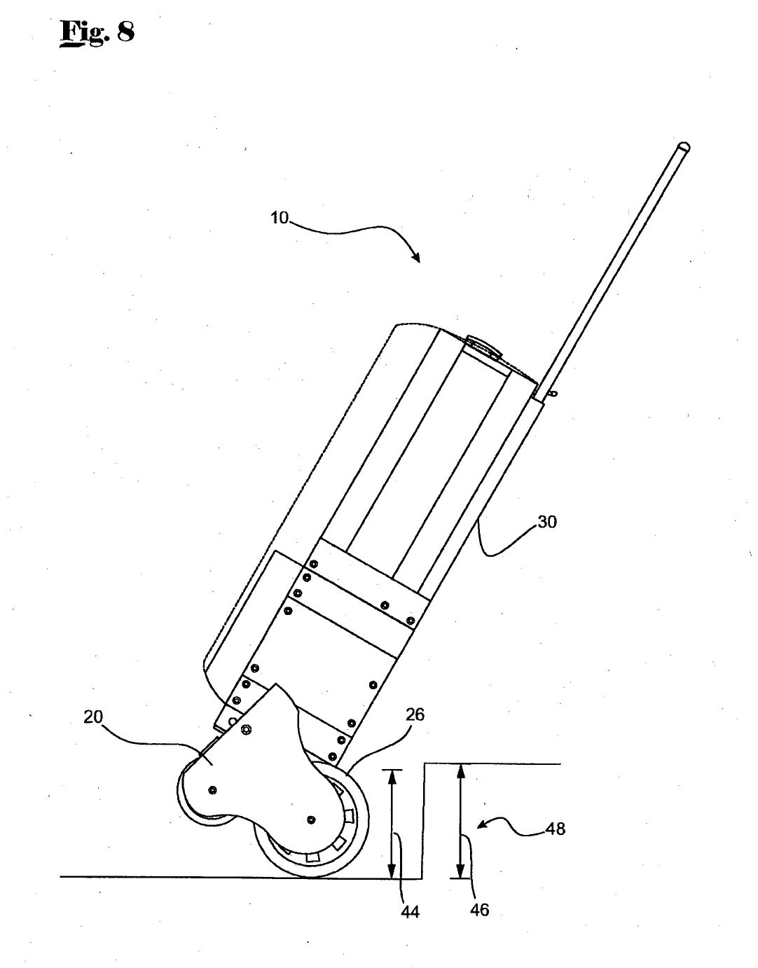

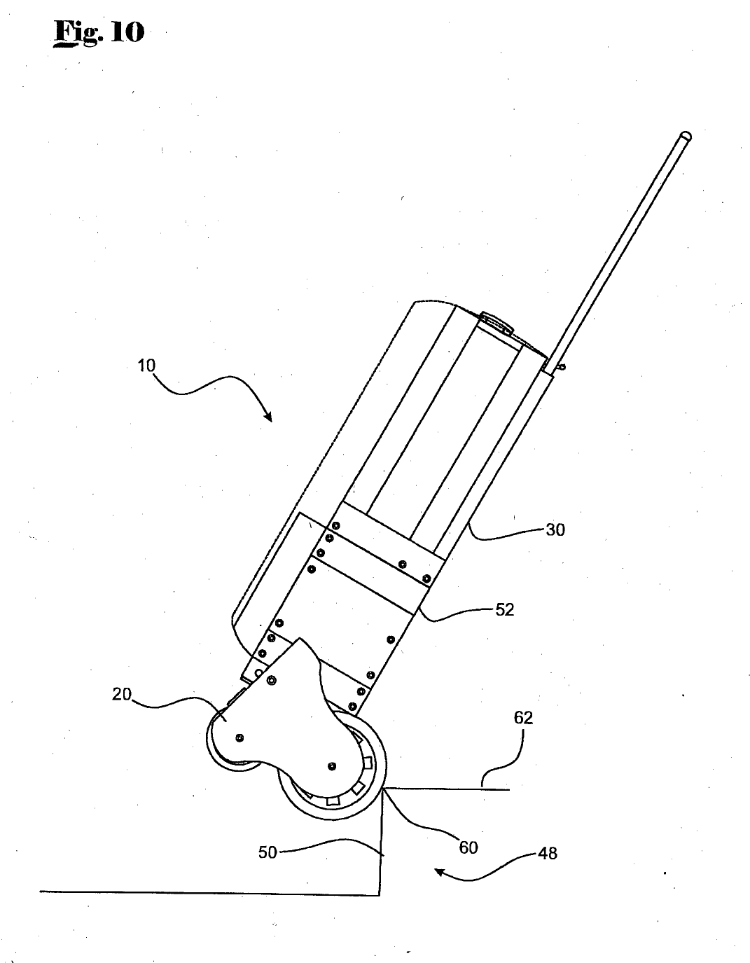

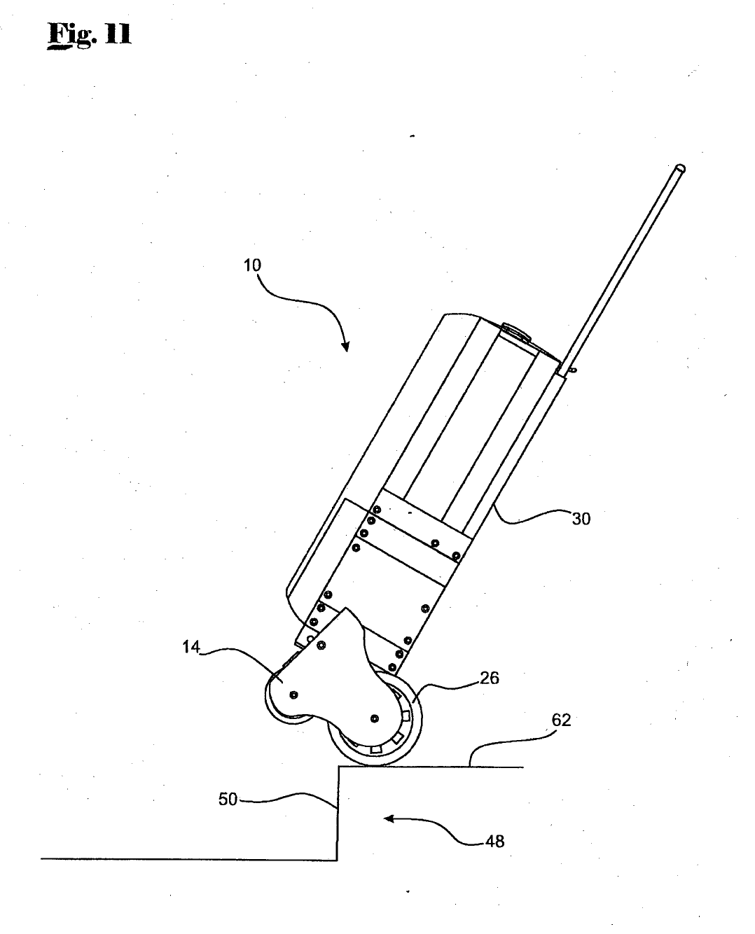

As shown in FIG. 7 when each large wheel 26 is in the rolling position 34 the wheel is disposed so as to extend horizontally across 40 and vertically down 42 so as to allow rolling movement along the ground and rolling movement up the face of a step, when the wheel assembly 20 is in a position to be pulled up the step by a person. The process of being pulled up a step is illustrated in FIGS. 8 to 11.

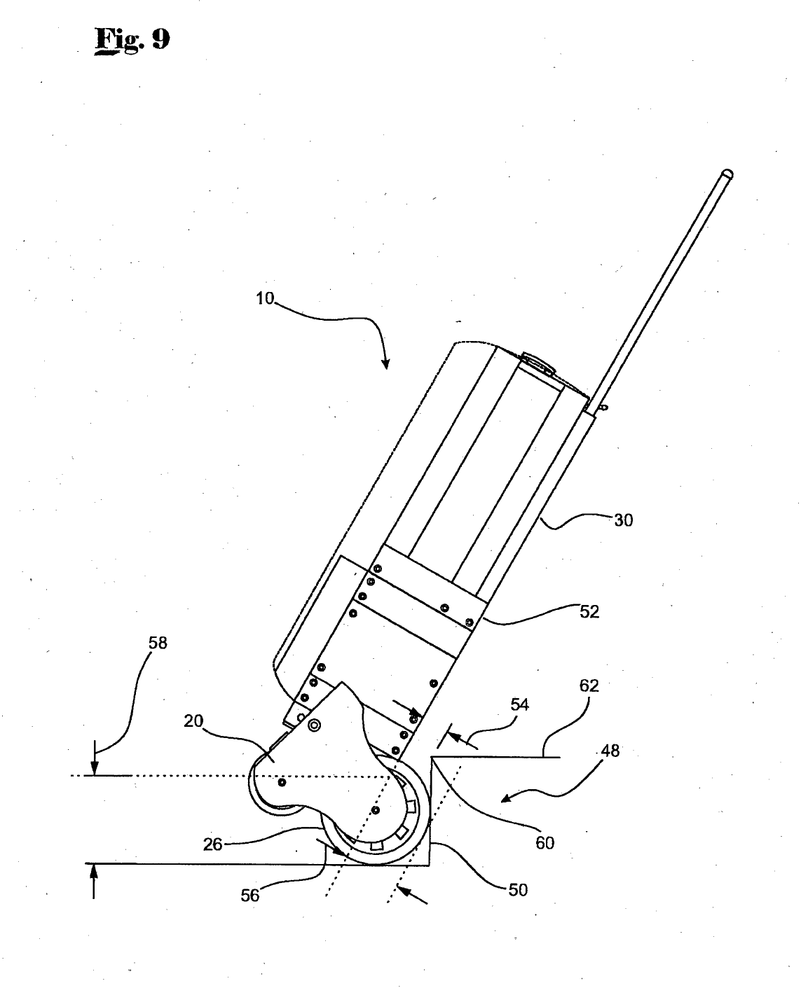

As shown each large wheel 26 is of a height 44 about the height 46 of a conventional step 48. As shown in FIG. 9, the wheels 26 are brought into engagement with face 50 of the step 48, without contact being made with the back 52 of the frame 30 of the carrier 10. A separation distance 54 is advantageously provided by virtue of the large wheels 26 extending beyond the back 52 of the frame 30. Advantageously the large wheels 26 extend beyond the back 52 of the frame 30 by about the radius of the large wheels 26. This is shown in FIG. 9 by the distance 56. The wheel system 14 also advantageously serves to provide the carrier 10 with an advantageous extension of the height of the carrier 10 by a distance 58. In embodiments this provides advantageous clearance over obstacles. The extension in height also advantageously serves to increase the height of the handle to the carrier 10.

Once each large wheel 26 has been brought into engagement with the face 50 of the step 48, the carrier 10 is pulled upwardly with the wheels 26 rolling up the face 48, over an edge 60 of the step 48 and onto a plateau 62.

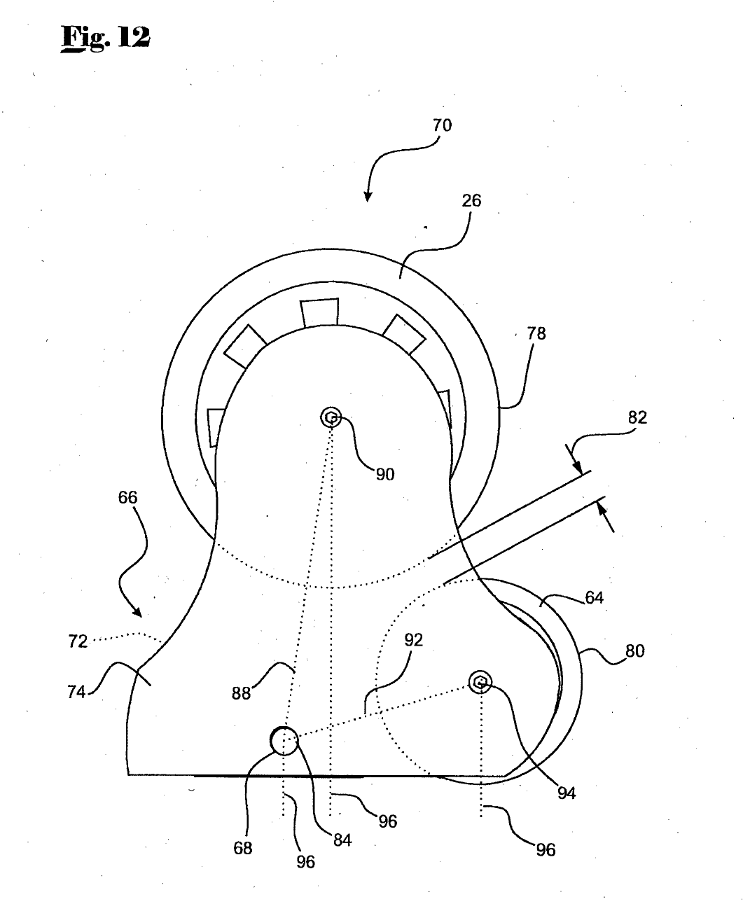

Referring to FIG. 12, each large wheel 26 is associated with a secondary wheel 64 in spaced apart relationship from the large wheel 26. Each large wheel 26 and the associated secondary wheel 64 form a wheel pair 66 of the wheel assembly 20. Each wheel pair 66 is pivotally mounted in the wheel assembly 20 at a pivot 68. In this embodiment two wheel pairs 66 are mounted on either side of the frame 30 as shown.

Each secondary wheel 64 of a wheel pair 66 is of a smaller diameter in comparison to the associated large wheel 26. More particularly each secondary wheel 64 is less than 60 percent of the diameter of the associated large wheel 26.

The pairs of large wheels 26 and secondary wheels 64 are mounted in a removable wheel mount 70 providing the wheel pair 66. The wheel mounts 70 each comprise a first plate 72 and an opposite plate 74 between which the wheels 26, 64 are mounted. The opposite plates 74 are disposed adjacent the frame 30.

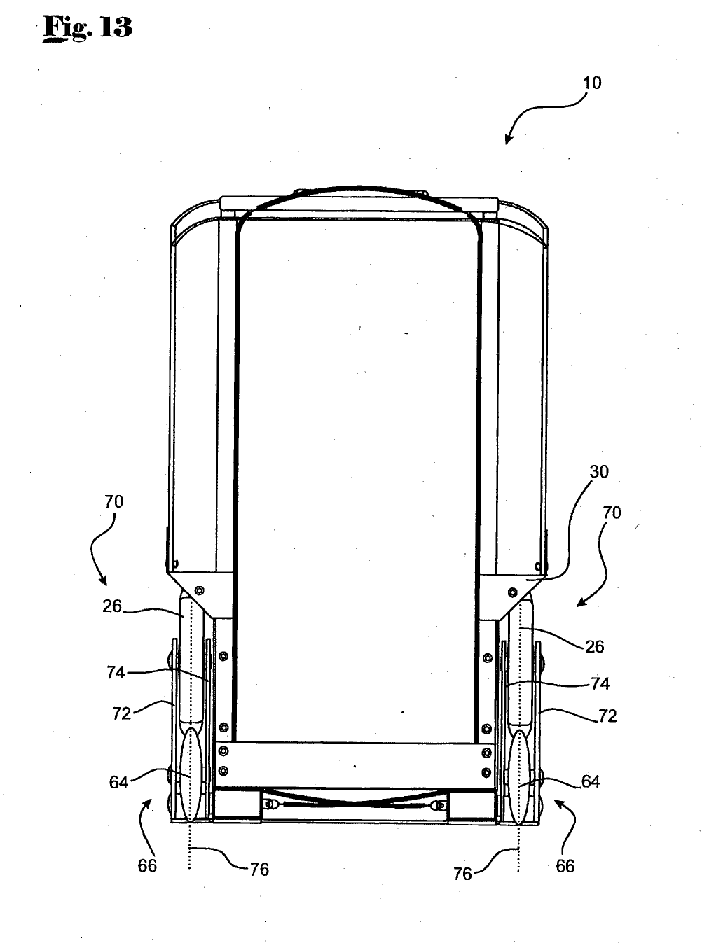

Referring to FIG. 13, in each removable wheel mount 70 the large wheel 26 and the associated secondary wheel 64 are arranged so that the wheels 26, 64 lie in the same rolling plane 76 associated with each wheel pair 66.

Returning to FIG. 12, the periphery 78 of the large wheel 26 is in close proximity to the periphery 80 of the secondary wheel 64. This is illustrated by the relatively small separation distance 82.

Each wheel mount 70 provides an opening 84 for receiving a removable pivot member 86, which in this embodiment comprises a bolt. As shown in FIG. 12, the openings 84 define the pivots 68. The pivots 68 provide a distance 88 to the axis 90 of the large wheel 26 and a distance 92 to the axis 94 of the secondary wheel 64. The extension mechanism 18 facilitates selective rotation of the wheel assembly 20 comprising the two removable wheel mounts 70 about the respective pivots 68 on either side of the carrier 10.

Each pivot 68 is positioned such that when the wheel assembly 20 is in the retracted condition 22, and the carrier 10 is upright, the axis 90 of the large wheels 26 are horizontally disposed between the pivots 68 and the axis 94 of the associated secondary wheels 64. This is illustrated by the vertical lines 96 in FIG. 12.

Furthermore, the pivots 68 are vertically disposed beneath the axis 90 of the large wheel 26 when in the retracted position 22. The distance 88 is greater than the radius of the large wheel 26. The distance 92 is greater than the radius of the secondary wheel 64.

Referring to FIGS. 13 and 14, when the wheel assembly 20 is in the retracted condition 22 the carrier 10 can still advantageously be rolled around in a similar fashion to a conventional suitcase. This arises in the retracted condition 22 as each secondary wheel 64 is disposed so as to slightly protrude beyond the back 52, of the frame by a distance 98.

The ability to be rolled around when the wheel assembly 20 is in the retracted condition 22 is considered to be particularly advantageous in airports where quick rolling movement often required on a generally flat surface. For example a traveller might have placed the wheel assembly 20 in the retracted condition 22 while waiting in the airport lounge and then wish to roll the carrier 10 around without having to use the extension mechanism 18 to dispose the wheel assembly 20 in the extended condition 24.

As shown in FIG. 14, in the retracted condition 22 each secondary wheel 64 is disposed in a position suitable for rolling along a relatively flat horizontal surface, with the associated large wheel 26 being disposed in an inoperative position thereabove.

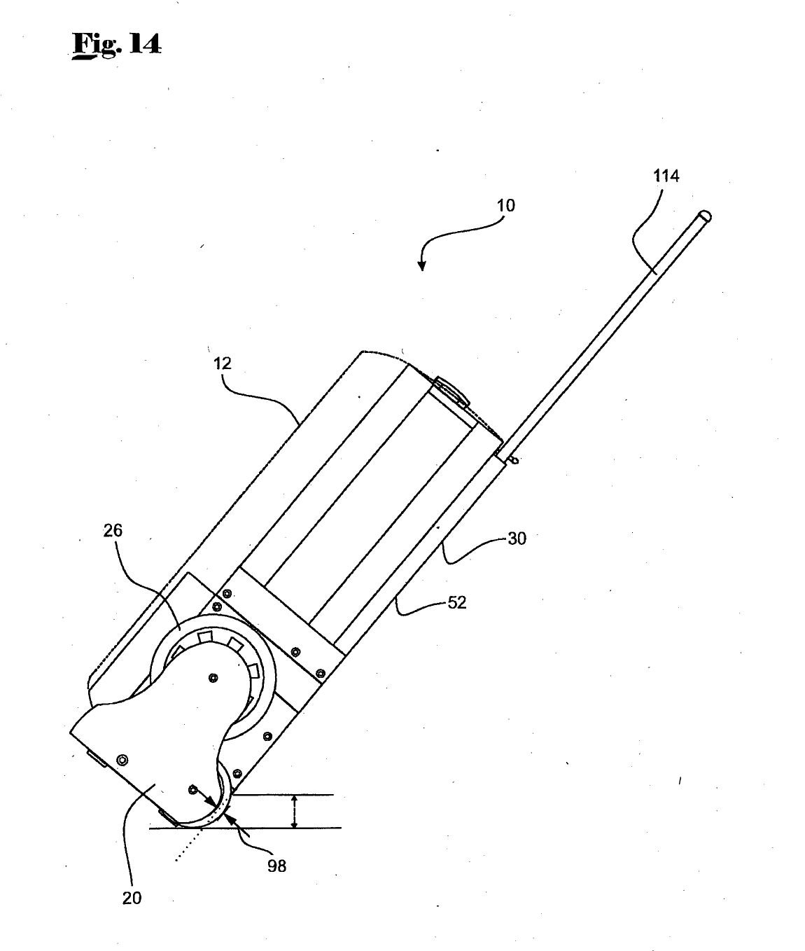

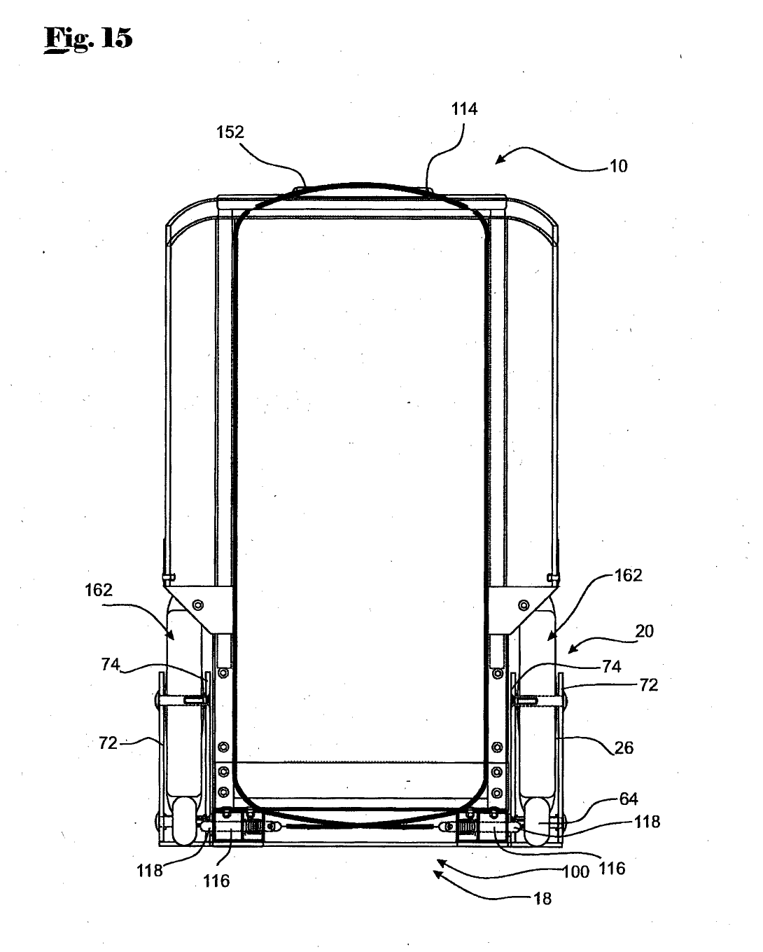

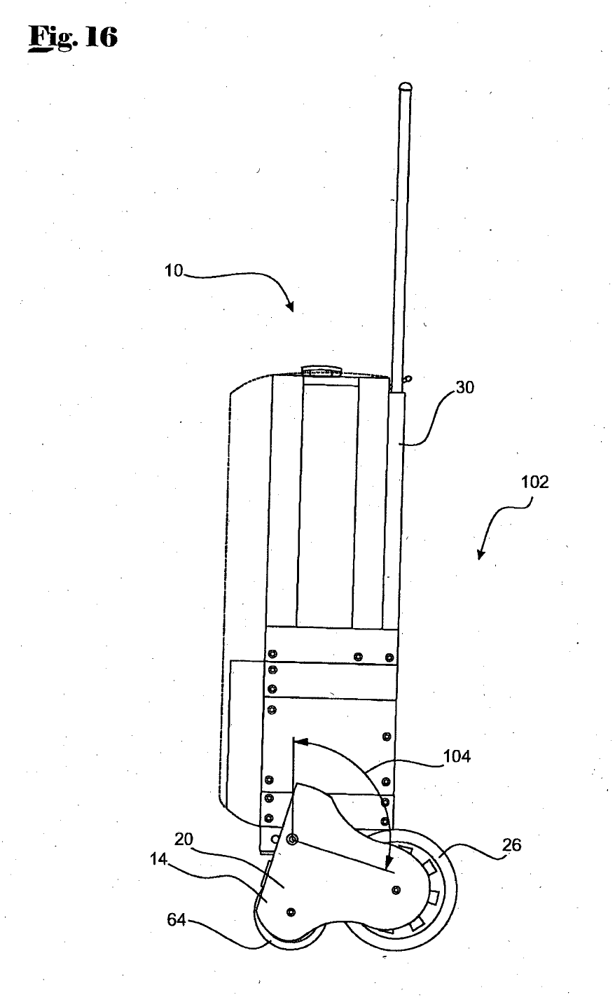

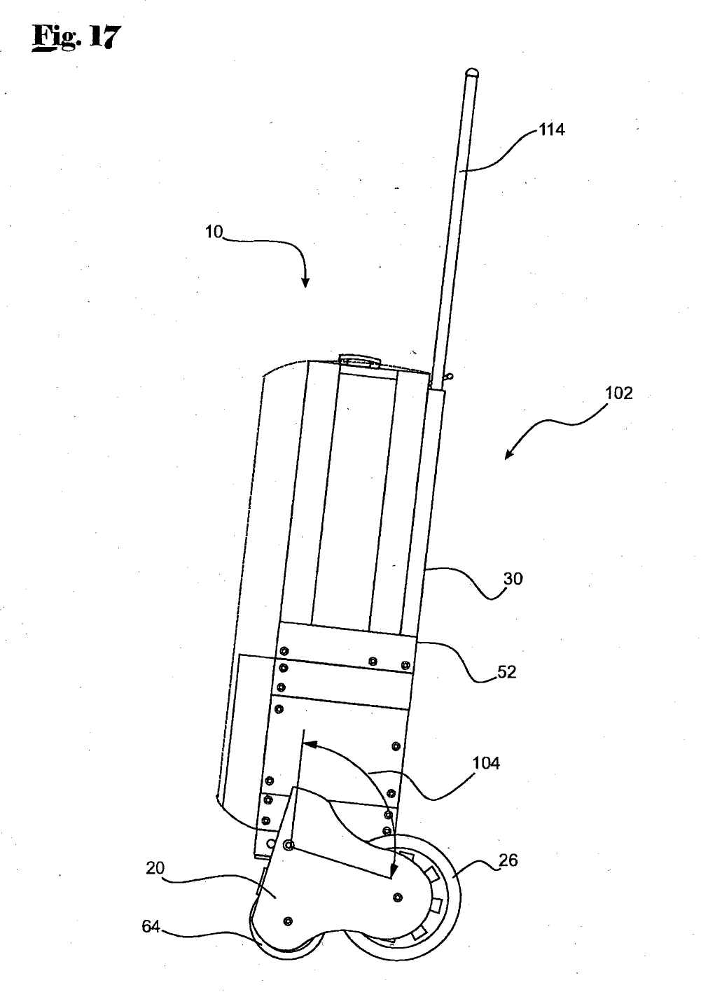

FIG. 15 illustrates a locking mechanism 100 forming part of the extension mechanism 18. The locking mechanism 100 is adapted to selectively lock the wheel assembly 20 in any one of a series of extended conditions 102 as illustrated in FIGS. 16 to 19. Notably the different extended positions and characterised by different locking angles 104. The locking mechanism 100 advantageously allows for the user to modify the centre of gravity of the carrier 10 relative to the wheel assembly 20.

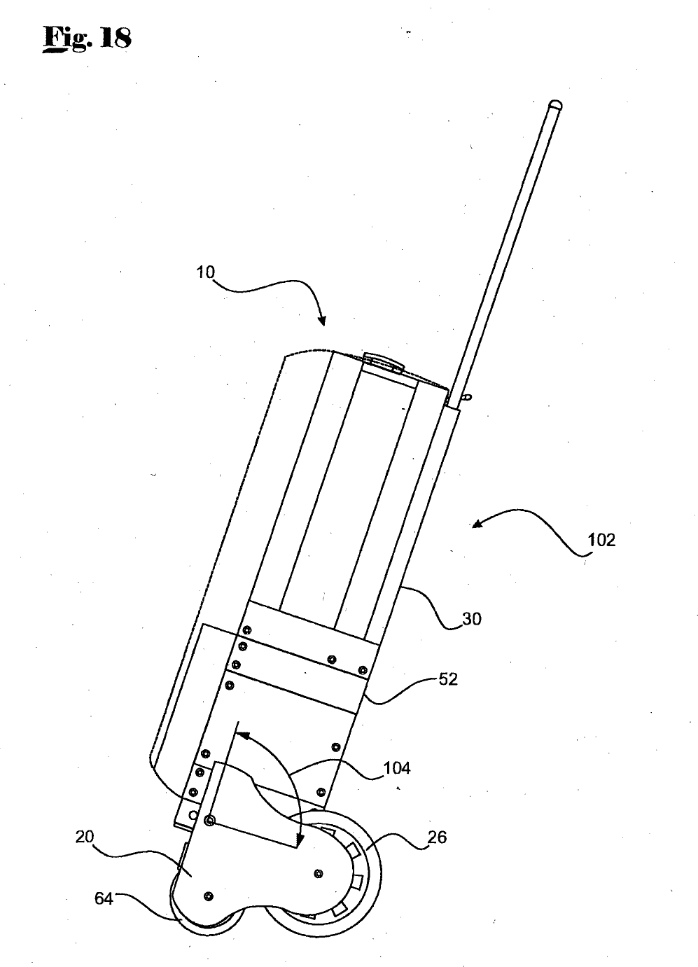

Referring to FIG. 19 the carrier includes a number of attachment elements 106 for the mounting of additional luggage 108. When the additional luggage 108 is attached to the carrier 10, the centre of gravity of the luggage 108 and load of the carrier 10 can be moved in the direction 110 so as to lie between the respective ground contacts areas 112 of the secondary wheels 64 and the large wheels 26.

In other words, the extended conditions 102 are associated with a different centre of gravity allowing the wheel assembly 20 to be readily rolled with different loading configurations. The wheel assembly 20 provides a four point ground contact with the large wheels 26 located towards the rear of the carrier 10 with the frame 30 being able to be secured in different positions relative to the wheel assembly 20.

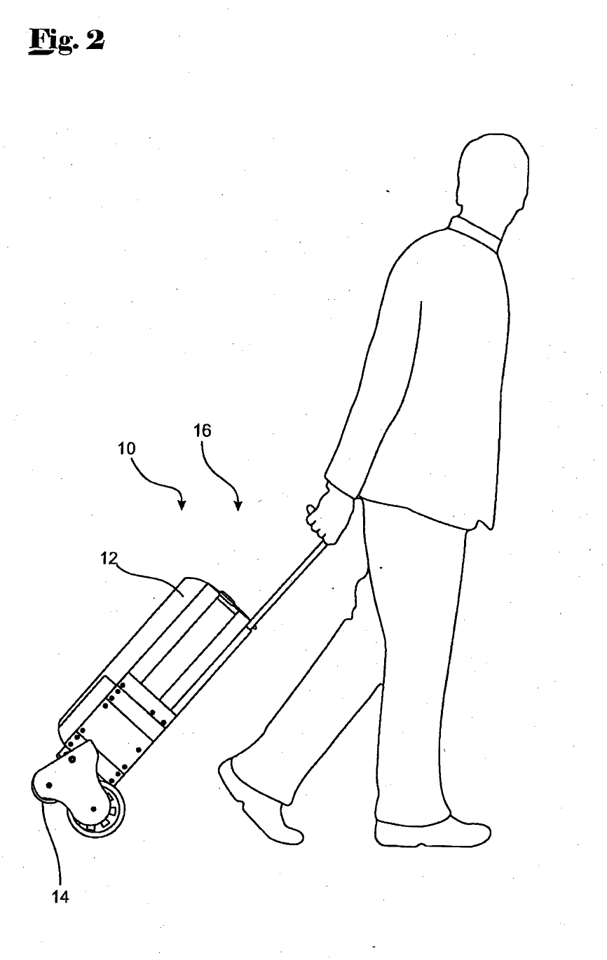

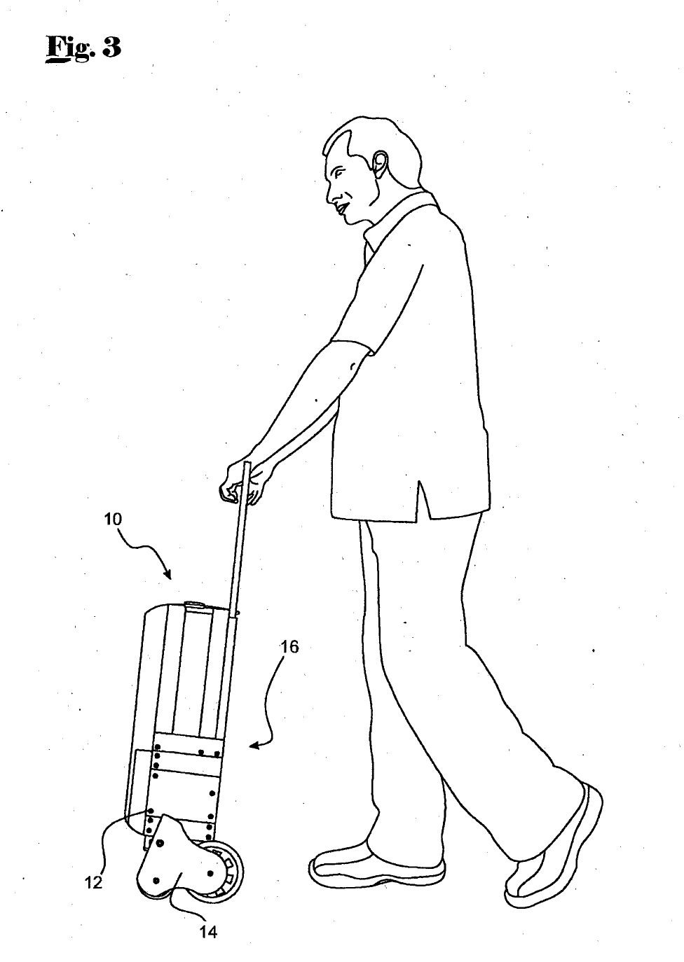

Returning to FIG. 17, in order to relocate the carrier 10 when in the extended configuration, a user is able to extend a handle 114 and pull the carrier 10 by the handle 114 with either the large wheels 26 or the secondary wheels 64 leading the direction of movement. This is also shown in FIGS. 2 and 3.

In the case of the secondary wheels 64 leading the moment, a user will typically push the handle 114 so as to force the secondary wheels 64 to lead in a forward direction, with the weight of the carrier 10 preventing forwarding tipping of the carrier 10 in the direction of movement.

FIG. 2 shows the large wheel 26 leading the direction of movement. In this position, the large wheels are pulled forward with the action causing the carrier 10 to tip in the direction of movement as shown in FIG. 2. On the pulling action of a person the carrier 10 accordingly tips forward so as to roll on each large wheel 26 with the associated secondary wheels 64 being raised in the air.

As shown in FIG. 15 the locking mechanism 100 includes releasable pins 116 mounted of the bottom of the frame 30. The release pins 116 are biased outwardly towards the plates 74 adjacent the frame 30 so as to extend through locking holes 118 in the plates 74.

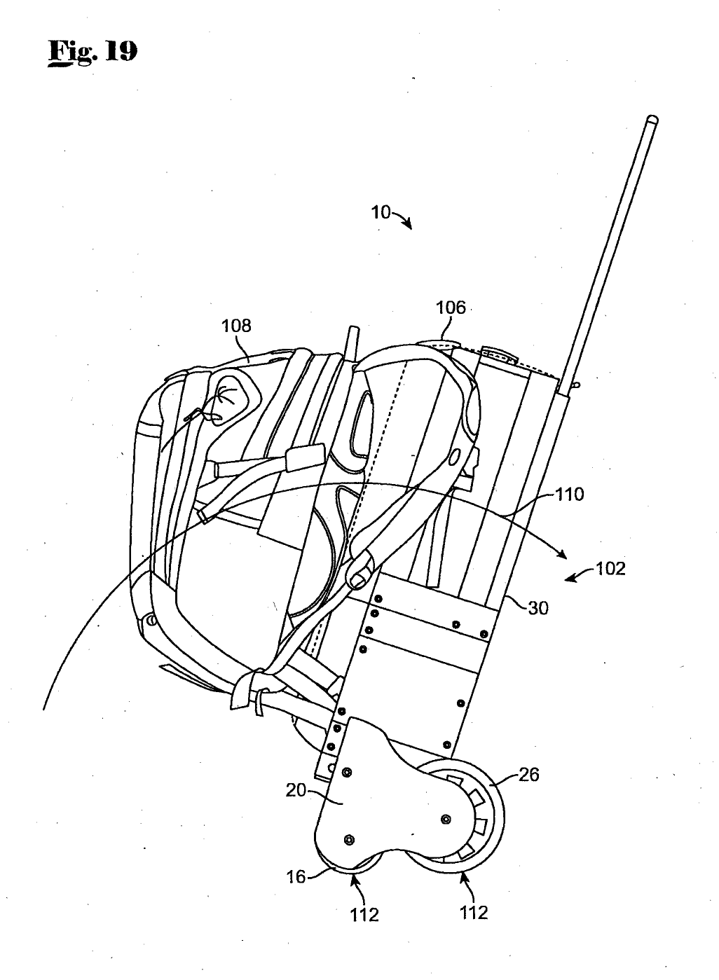

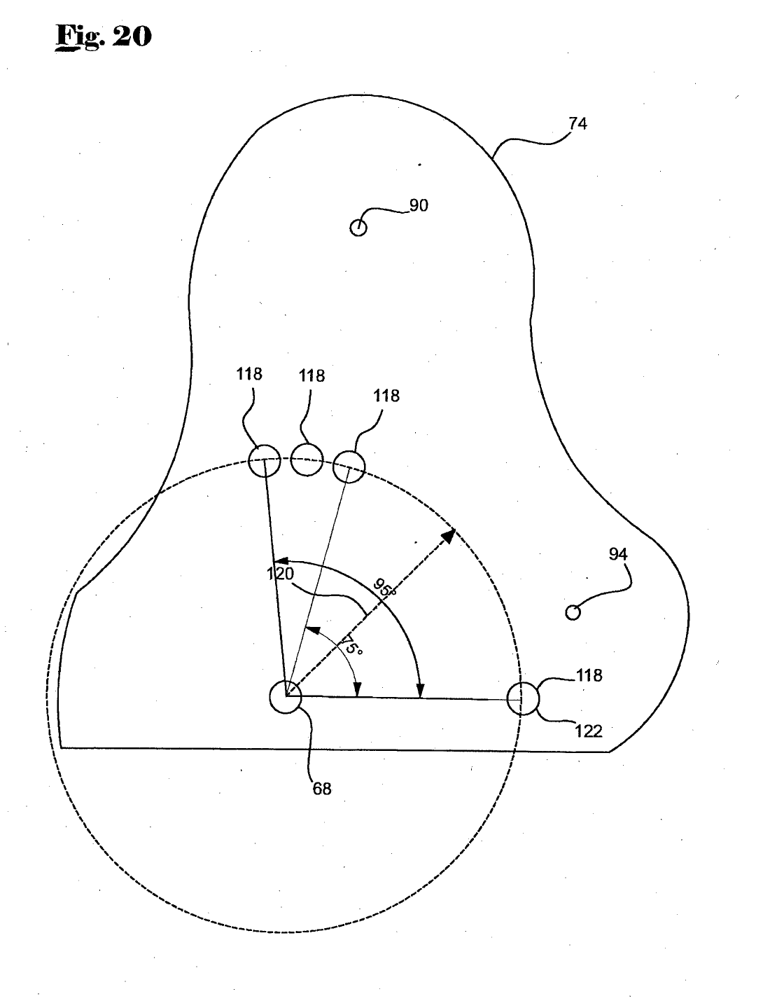

Referring to FIG. 20 the locking holes 118 are arranged around a radius 120 of the pivot 68. A first locking hole 122 is provided to allow a corresponding locking pin 116 to extend therethrough and lock the wheel assembly 20 in the retracted condition 22. In order to allow the wheel assembly 20 to be locked in the extended conditions 102 (corresponding with condition 24) a number of further locking holes 124 are provided at different angles about the pivot 68. The angles in this embodiment range from at least 70 degrees to at least 90 degrees. Three extended positions 102 are provided.

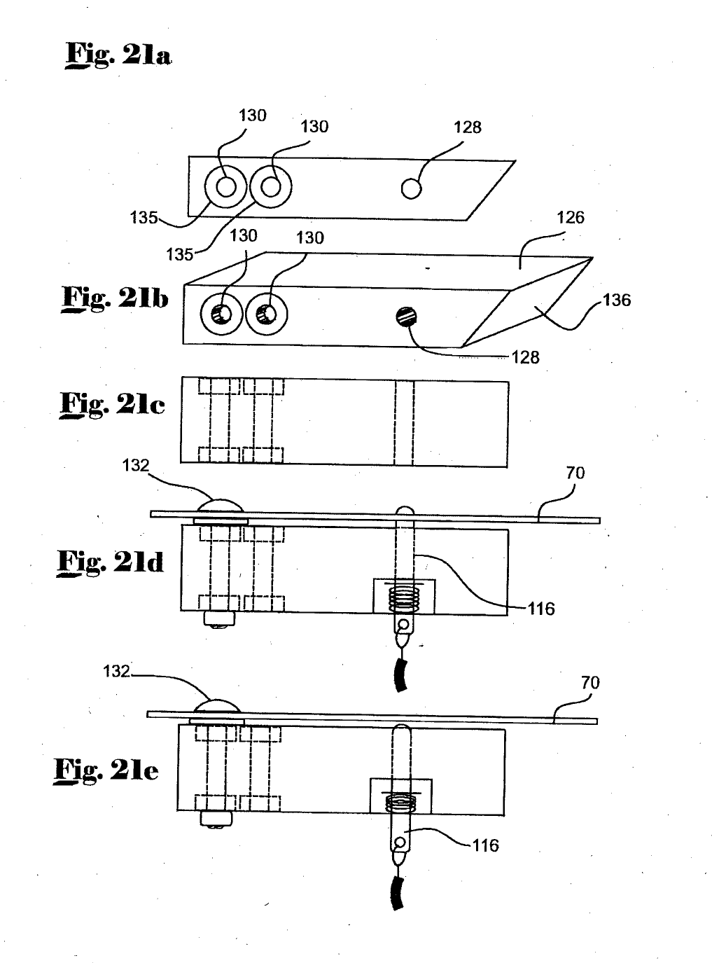

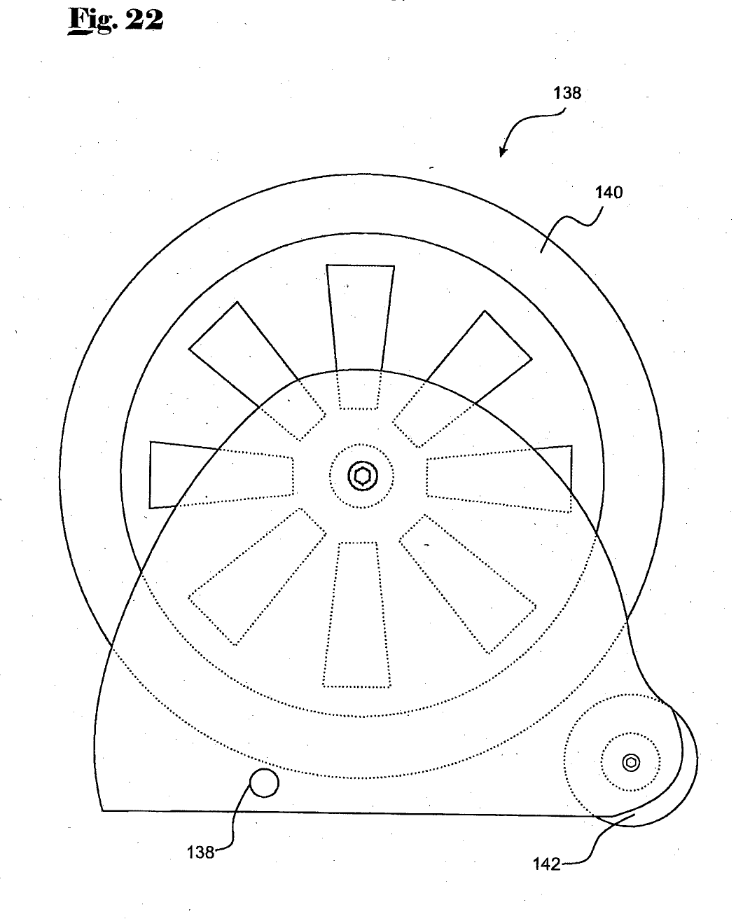

Referring to FIG. 21 the locking pins 116 are mounted within a frame mount 126. The frame mount 126 includes a first passage 128 for receiving the locking pin 116 and two other passages 130 for receiving a bolt 132 that extends through the opening 84 in the removable wheel mount 70 schematically shown in FIG. 21. The reason why a number of passages 130 are provided in the frame mount 128 is to accommodate different wheel mounts 70 where the wheel mounts may have the pivot 68 positioned differently due to the particular configuration. As shown in FIG. 22 the frame mounts 126 extend a substantial distance along the bottom of the frame 30 and together with the frame 30 provide a rigid section 134 upon which the user is able to sit. The frame 30 provides a rigid reinforced structure.

Furthermore the passages 130 include a number of bearings 135. The bearings 135 in this embodiment are provided as roller bearings. The roller bearings 135 provide axle mounts at the pivot to advantageously provide a tight mating of the castor (the wheel mounts 70) to the frame 30 with very low resistance when extending or retracting the wheel mounts 70.

The frame mounts 126 include an inclined end portion 136. The frame mounts 126 are designed to be particularly robust as once the locking pins 116 ‘lock in’ when the release handle is released, the locking pins transfer all of the weight of the frame 30 and carrier 10 load to the wheel assembly 20.

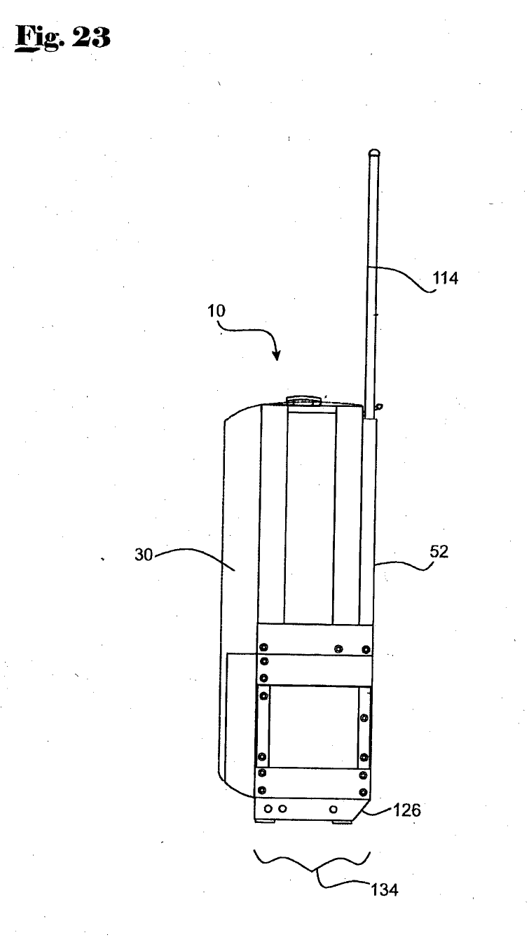

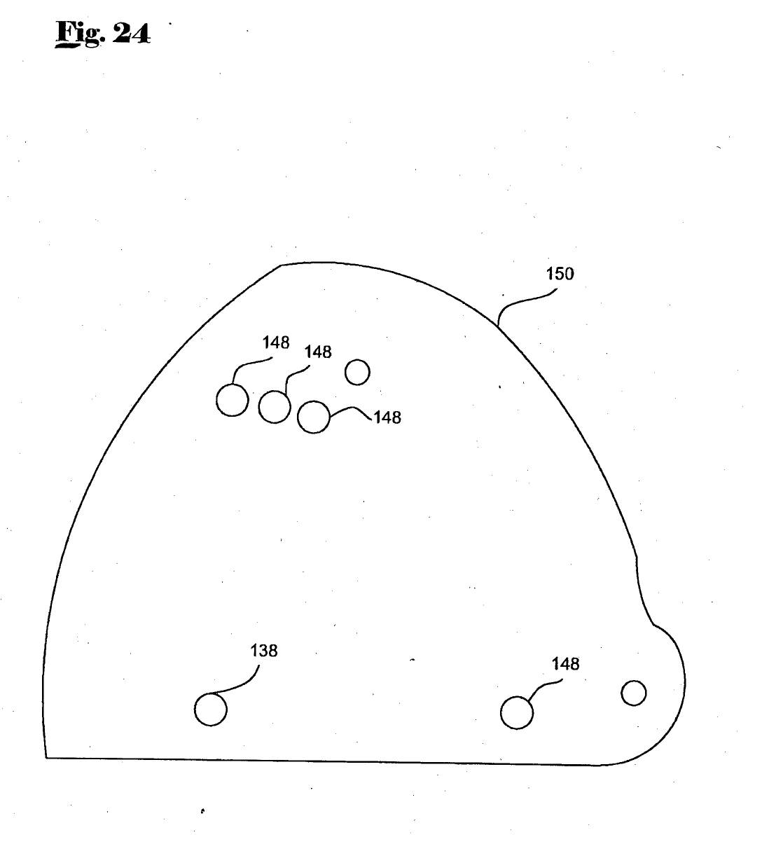

A different configuration of removable wheel mounts 138 in shown in FIGS. 23 and 24 accordingly to a further preferred embodiment of the present invention. Each wheel mount 138 includes a large wheel 140 of a diameter about 4.5 times the diameter of a small associated wheel 142. A pivot 138 is also provided.

In the case of the carrier 10 the wheel mounts 70 can be readily replaced with the wheel mounts 138 where the advantages of having a particularly large wheel 140 are desirable.

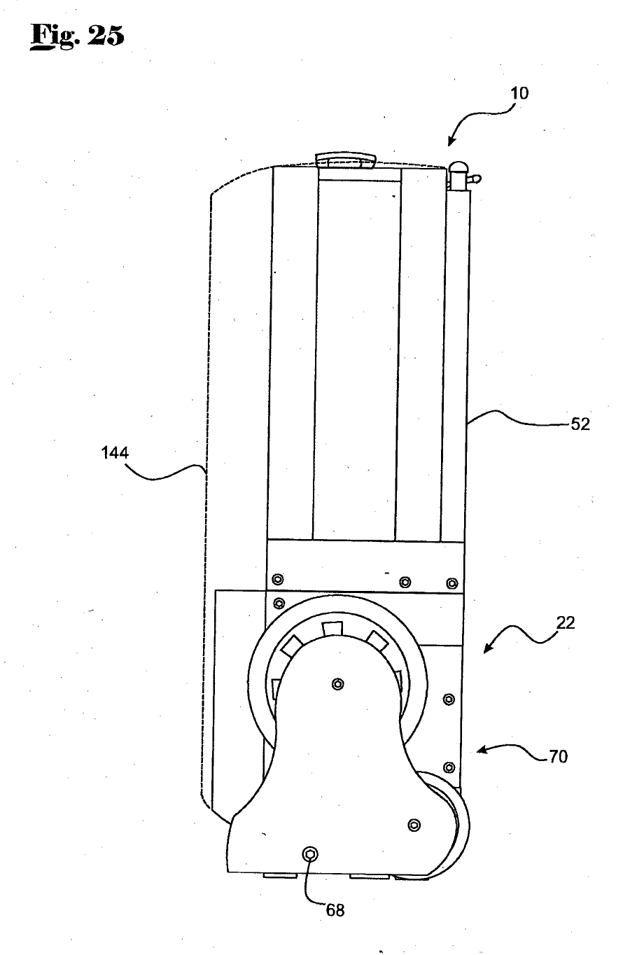

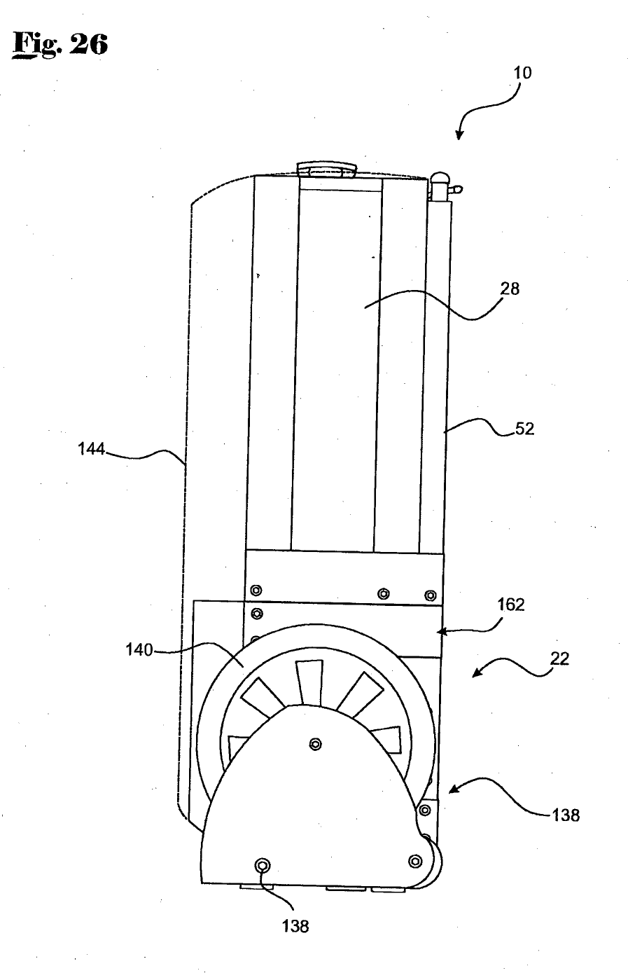

A comparison of the removable wheel mounts 138 and removable wheel mounts 70 mounted in the retracted condition 22 on the frame 30 is illustrated in FIGS. 25 and 26. The different locations of the pivot 68 and the pivot 138 would be apparent from FIGS. 25 and 26.

The pivot 138 of the wheel mount 138 is spaced closer to the front 144 of the carrier 10. Referring to FIG. 27 this limits limit the distance 146 the large wheel 140 protrudes beyond the back 52 of the carrier 10.

Returning to FIGS. 21 and 22, the locking pins 116 have a tapered tip and are configured, in this embodiment, to apply positive pressure on the corresponding locking holes 148 in the adjacent plate 150. Notably the pins 116 are slightly larger than the holes 148 in the plate 150. This is considered to be advantageous as the locking pins 116 are not able to move fully into the holes 148 and do not rattle when the carrier 10 is rolled. As shown in FIG. 15, the locking mechanism 100 includes a cable 152 that extends through the top of the carrier 10 adjacent the handle 114. Pulling the cable 152 retracts the locking pins 116 to release the wheel assembly 20. Various forms of locking mechanism 100 are envisaged.

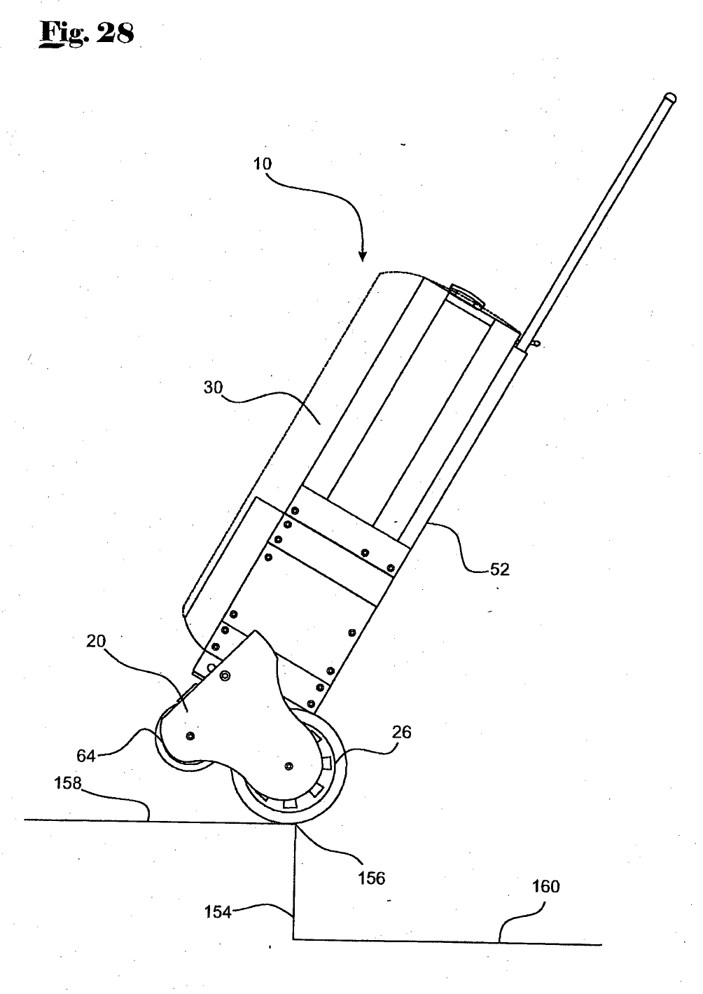

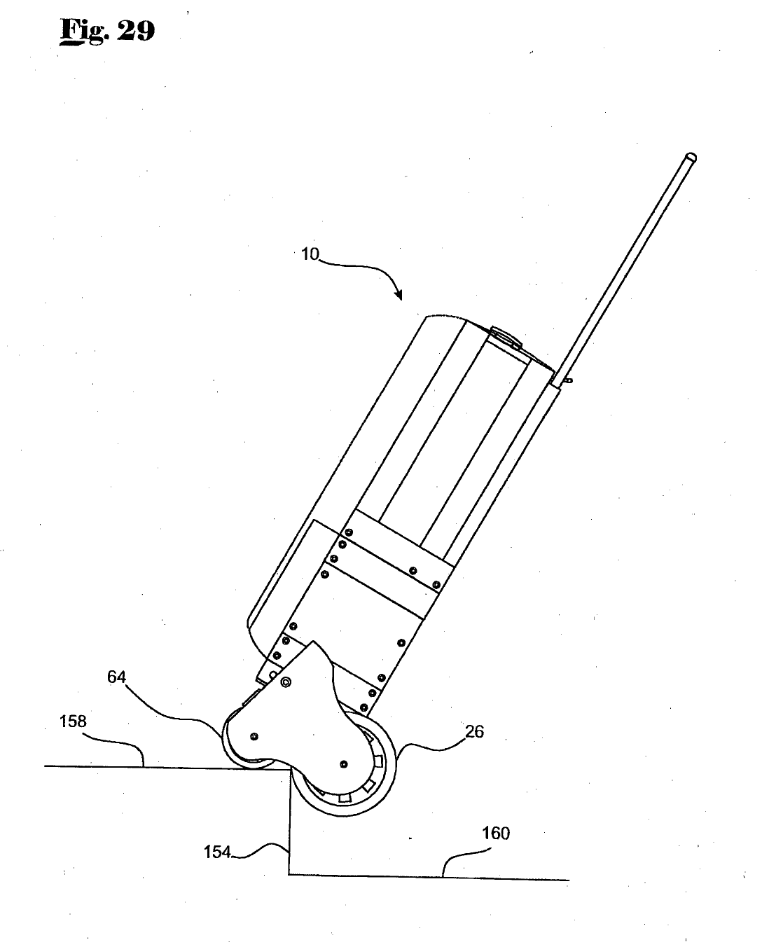

The manner in which the carrier 10 is able to advantageously accommodate a flight of stairs is shown in FIGS. 28 to 31. With the wheel assembly 20 in the retracted condition 22 a user retracts the releasable pins 116 by pulling the cable 152 that extends through the top of the carrier 10.

The cord 152 pulls the pins 116 away from the plates 74. At the same time the users lifts the carrier 10 by a top handle such as handle 114. As a result this causes the wheel mounts 70 to drop by virtue of the centre of mass of the wheel mounts 70 being spaced away from the pivot 68 (towards the back 52 of the carrier 10). A stopper (not shown) is provided on the frame 30 and the wheel mounts 70 so as prevent rotation beyond a maximum angle, corresponding with the most upright position of the frame 30 in the extended conditions 102. Various stopper arrangements are possible.

As would be apparent the maximum angle corresponds with the maximum clearance and, as noted, the most upright position when the wheel assembly 20 is extended.

When the wheel assembly 20 is one of the extended conditions 102 the carrier 10 can be pulled down a step 154. Before the large wheels 26 roll over the over the edge 156 of the step 154, the secondary wheels 64 are raised in the air. As the large wheel 26 falls over the edge 156, the secondary wheels 64 move downwardly and contact the upper surface 158 of the step 154 so as to arrest the fall of the carrier 10 and the wheel assembly 20 by contact with the upper surface 158 before the large wheels 26 contact the upper surface 160 of the next step. This is illustrated in FIGS. 28 to 31. When on the flat surface 160 the carrier 10 can be continued to be pulled with the large wheels 26 in the leading position. Alternatively the carrier 10 can be positioned as shown in FIG. 3 and pushed with the secondary wheels 64 in the leading position. In the upright position the carrier 10 as shown in FIG. 3, the carrier can be stably rested without the assistance of a person.

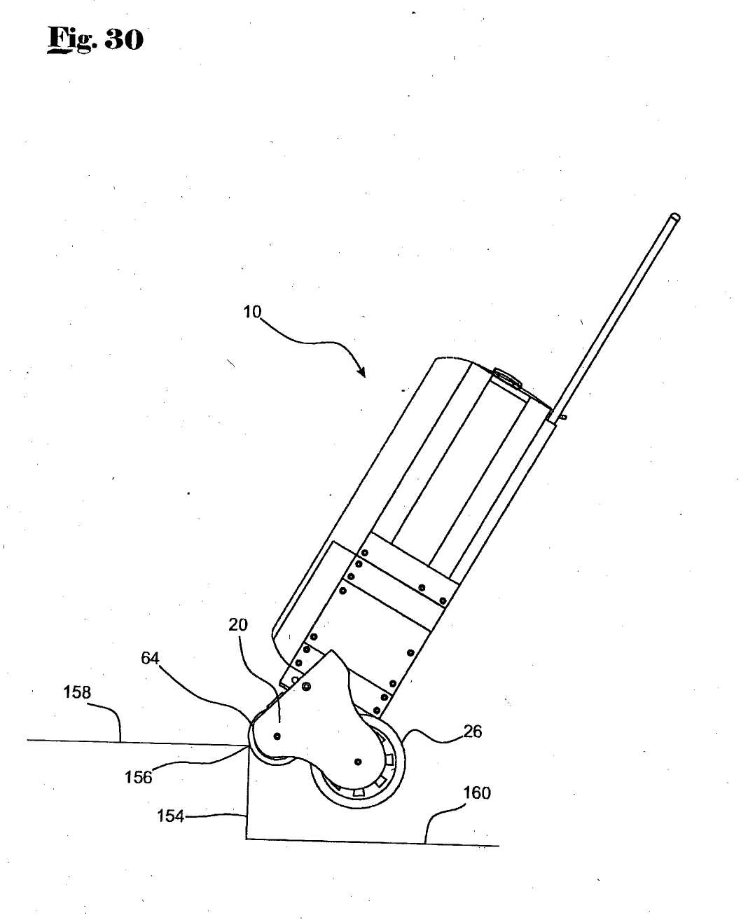

In order to move the wheel assembly 20 from the extended condition 24 to the retracted condition 22, the pins 116 are released and the carrier 10 is tipped towards its front 144 to allow ready rotation back to the retracted position 22. This is illustrated in FIG. 32.

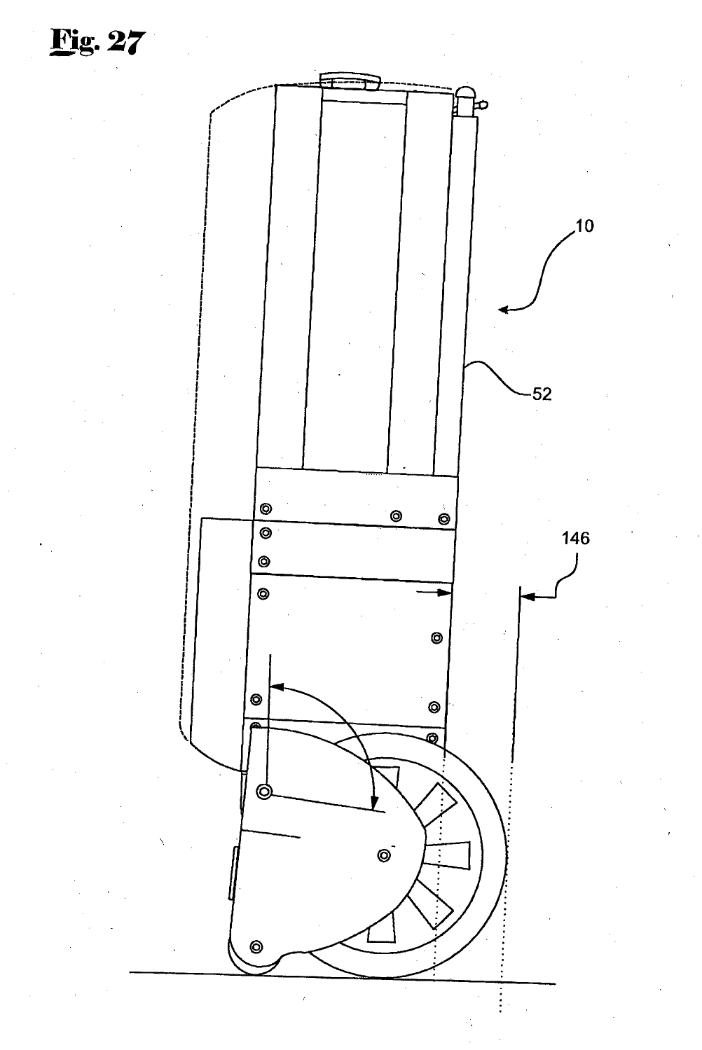

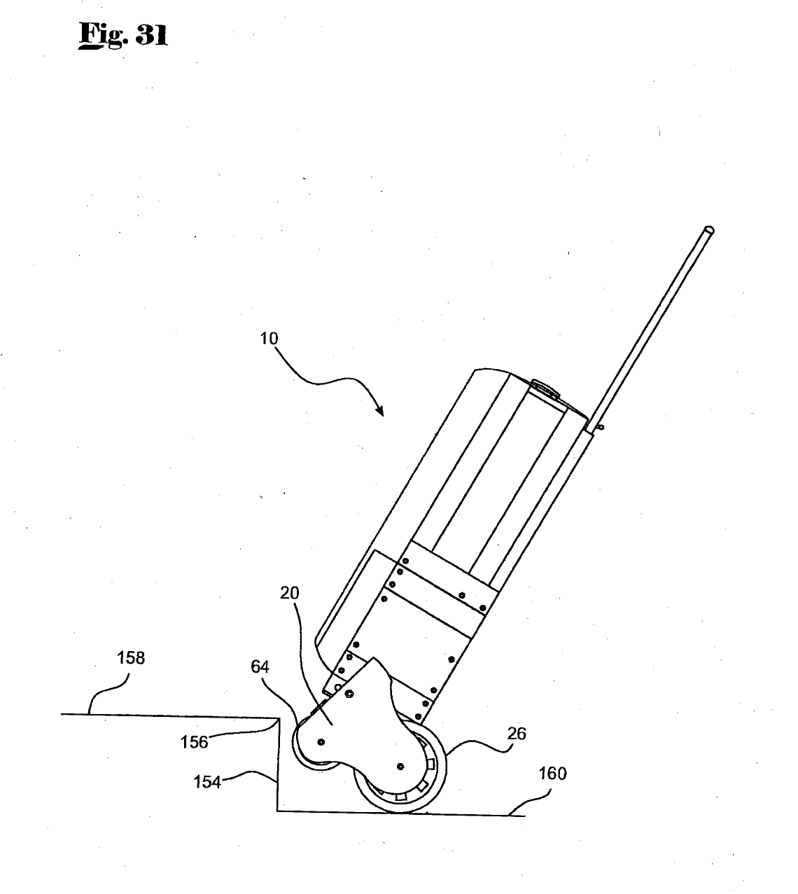

Referring to FIGS. 29 and 33 the plates 72, 74 advantageously have a contour 164 between the associated large wheel 26 and the secondary wheel 64 that prevents the wheel assembly 70 being caught on a step. Referring to FIG. 32 the contour 164 is chosen so that the tangents 166 to the wheels 26, 64 meet before the contour 164. In other words the plates 72, 74 are shaped so there is a clearance between the large and small wheel so as not to have any contact of the plates with the ground surface when going down steps or over other similar objects.

Without the ‘cutaway’ the plate would contact the ground or object and might stop the movement of the carrier.

The wheel mounts 70 can be readily replaced with wheel mounts 138 by removing and replacing bolts. As shown in FIG. 26, when the wheel mounts 138 are mounted, each large wheel 140 overlies a respective side 28 of the lower end of the frame 30 so as to span the substantial width of the side 28, from the front 144 the carrier 10 to the back 52 of the carrier 10.

In order to provide a relatively continuous contour the frame 30 is provided with lower recesses 162 (See FIGS. 15 and 26) for accommodating the wheel mounts 70, 138 of the wheel assembly 20 in the retracted condition 22.

The wheel mounts 138 are considered to be more suitable in situations where the carrier 10 must be rolled on uneven and relatively unforgiving terrain. The wheel mounts 70 are considered to be more suitable for airport travel and movement up and down a flight of stairs.

In the embodiments described the carrier system 10 has a rigid frame to withstand knocks and bumps associated with the all-terrain nature of the carrier 10. In the retracted condition 22 a person can also advantageously sit on the top of the frame 30 without damaging the carrier 10.

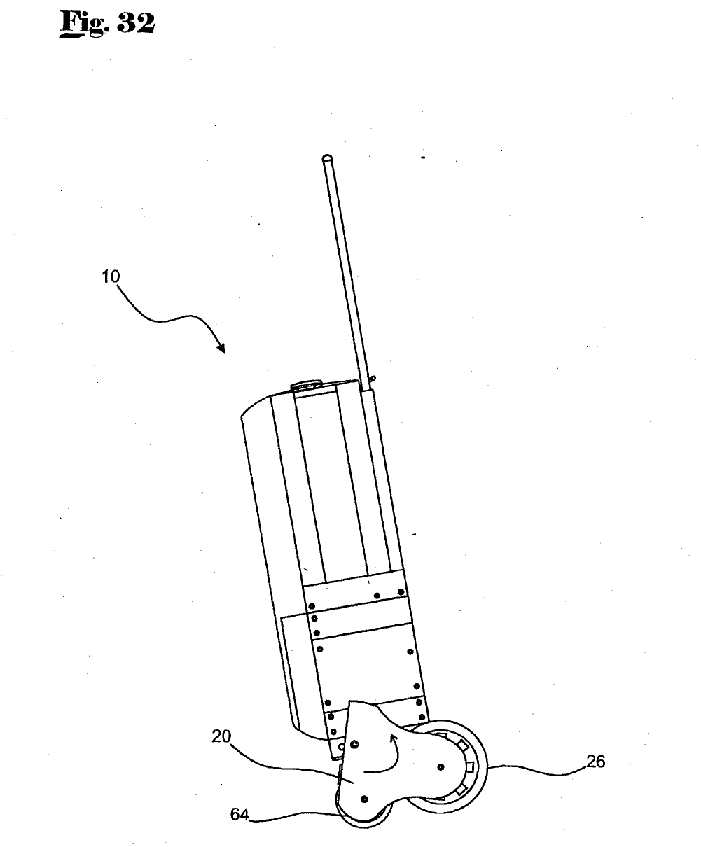

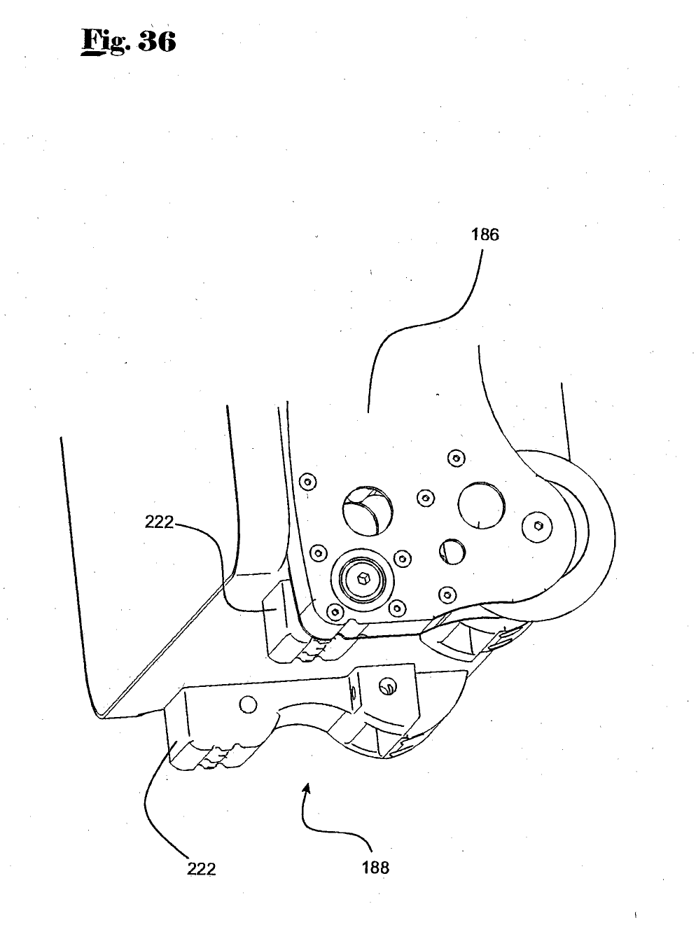

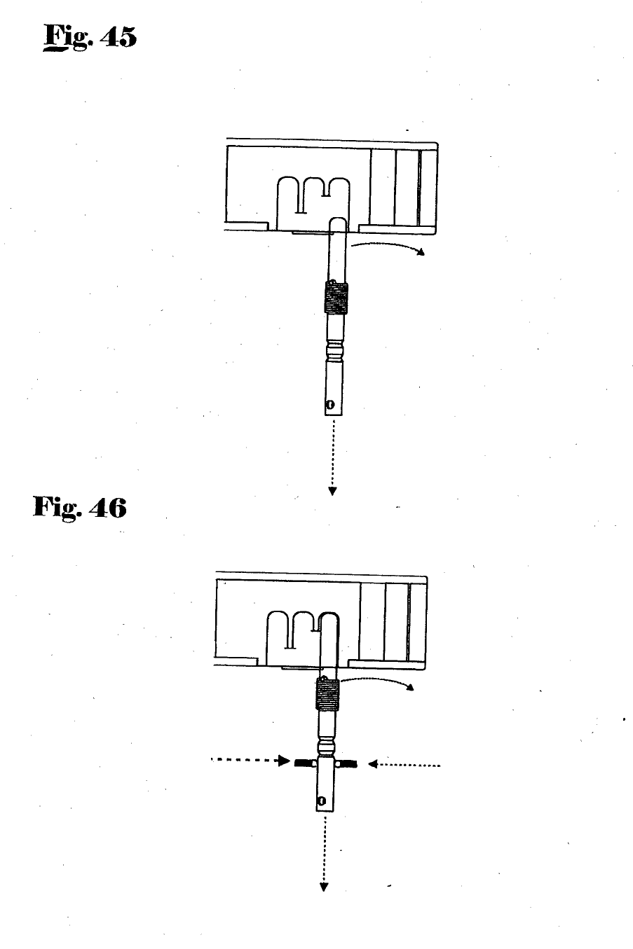

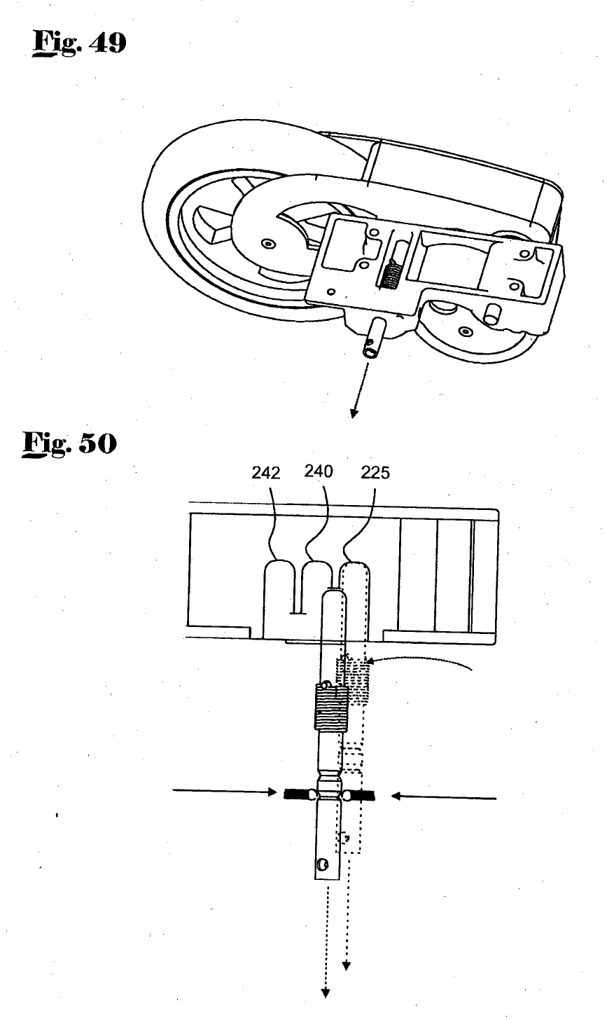

Referring to FIGS. 34 to 52 there is shown a further preferred embodiment of the present invention. The embodiment is provided in the form a suitcase 180 having a wheel assembly 182. The wheel assembly 182 is provided on the lower end 184 of the suitcase 180. The suitcase 180 includes pairs of wheel assemblies 186. The wheel assemblies 186 are moveable between a retracted condition 188 (See FIGS. 34 to 36) and a fully extended condition 190 (See FIG. 37).

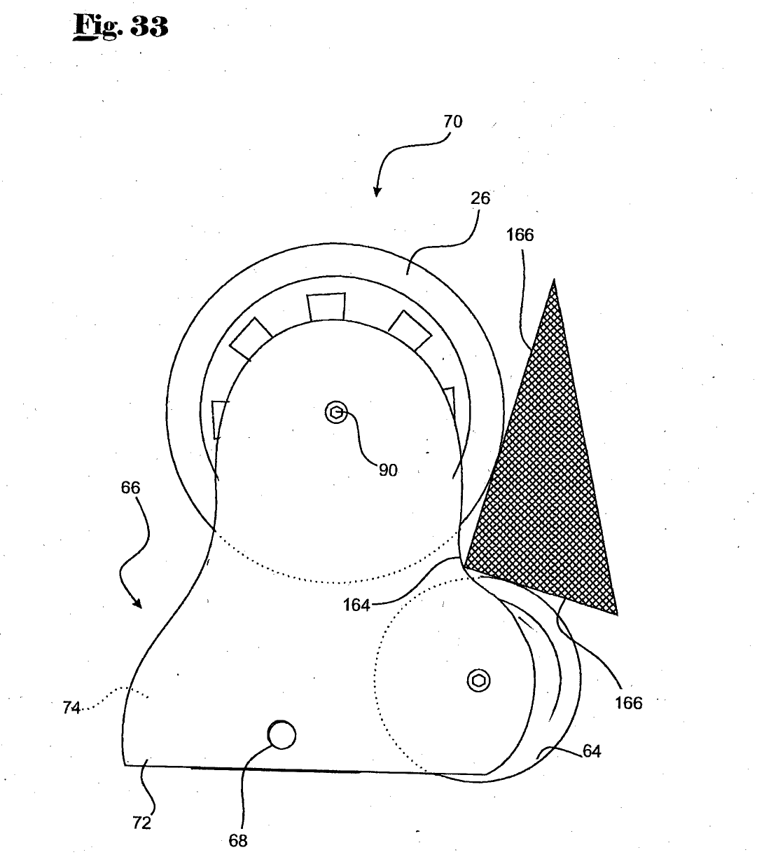

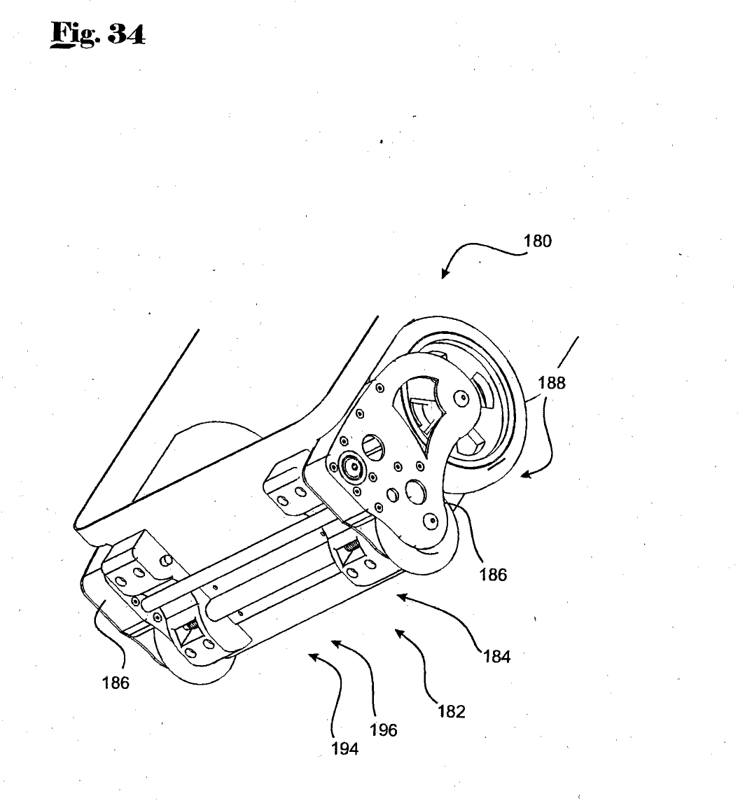

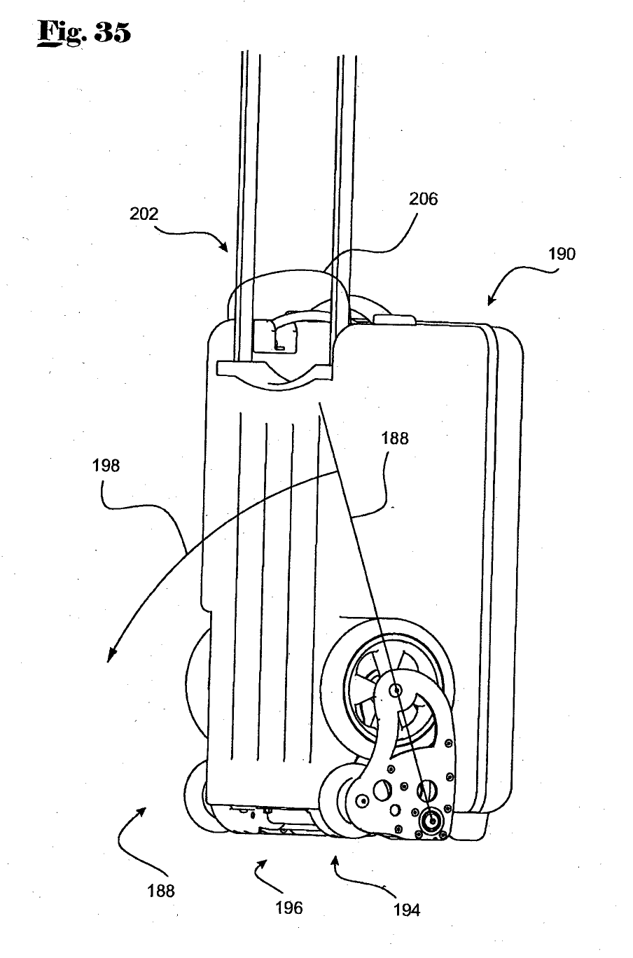

The wheel assemblies 186 are extendible using an extension mechanism 194. The extension mechanism provides a locking mechanism 196 for selectively locking the wheel assemblies 186 in any one of a series of extended conditions 198 including the fully extended condition 190. The nature of the extended conditions 198 has been previously described in relation to the earlier embodiments. For this reason the extended conditions 198 are represented as an arrow in FIG. 35.

The extended conditions 198 are relatively close there being an angular difference of about 10 degrees in this embodiment. Notably the extended conditions 198 comprise three discrete extended conditions. In other embodiments the extended conditions could be continuous.

Referring to FIG. 35, the locking mechanism 196 includes an actuation mechanism 200 having an actuator 202. The actuator 202 comprises a cable 206 that is connected to the extension mechanism 194.

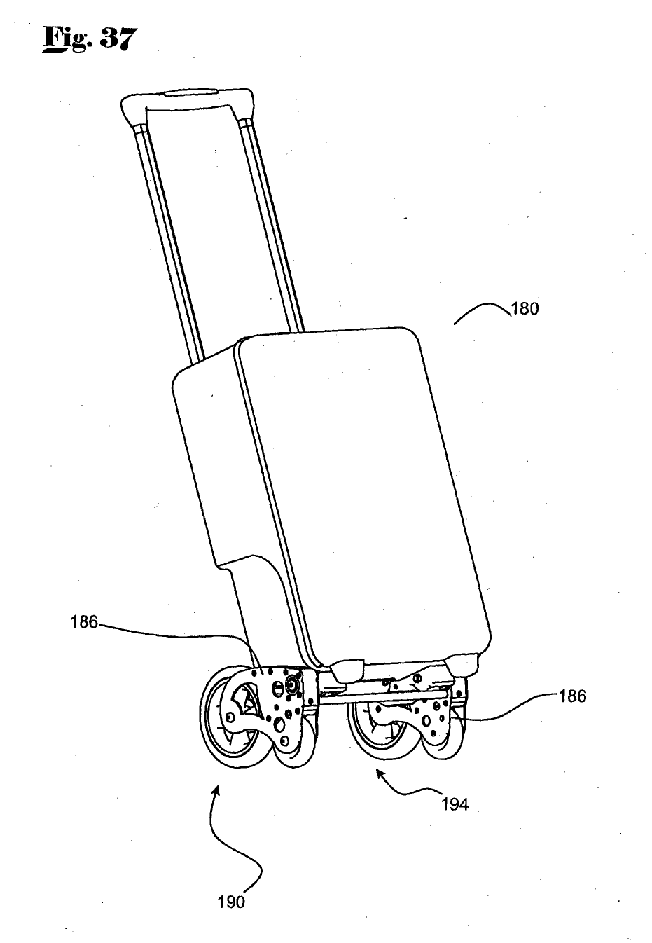

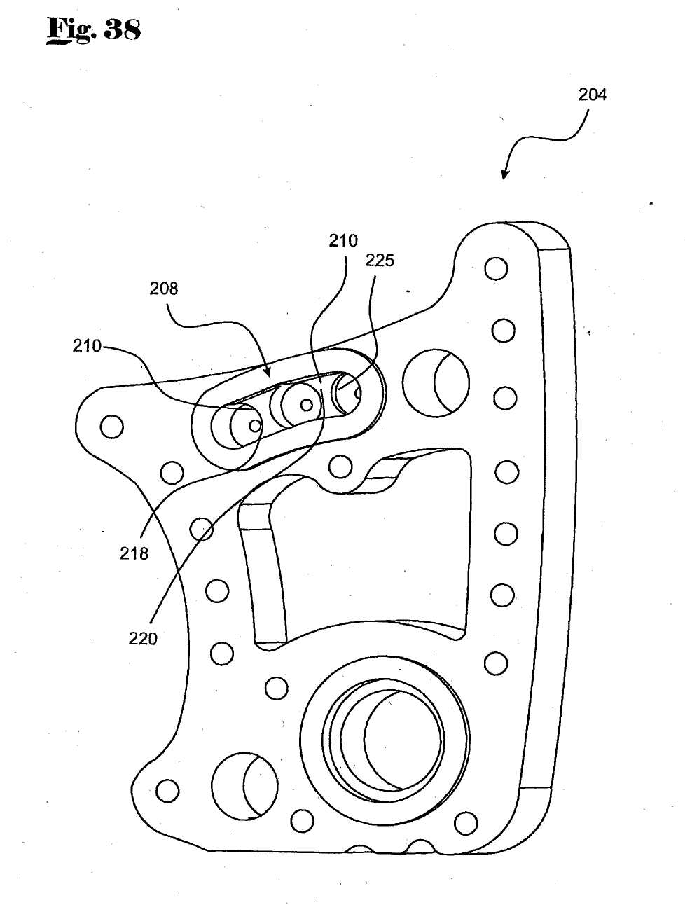

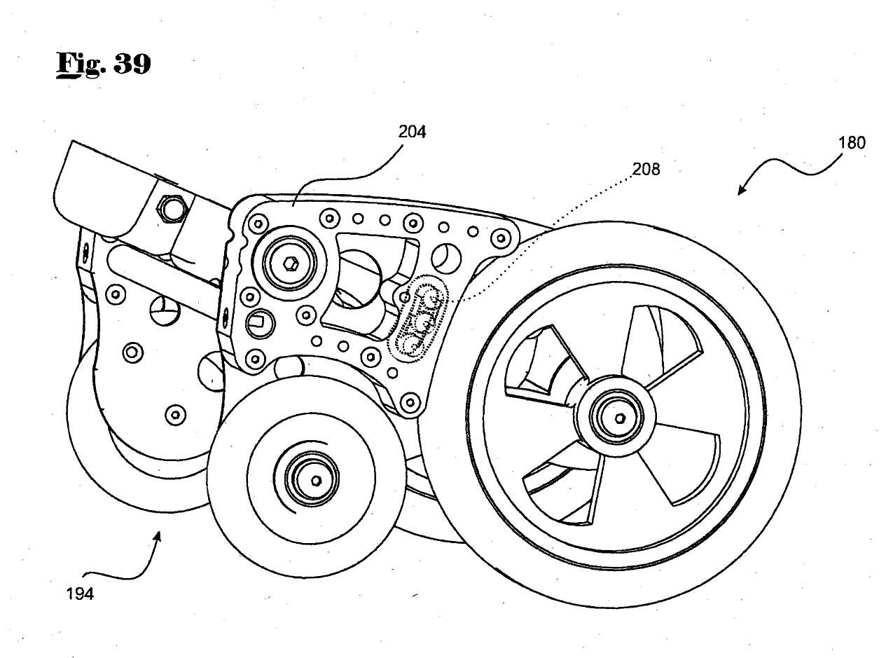

Referring to FIGS. 38 and 39, the locking mechanism 196 includes a limiter 204. The limiter 204 is configured to require a first degree of actuation to allow movement from the retracted condition 188 towards the near most extended condition 198. Advantageously the first degree of actuation required by the limiter 204 is sufficient to bypass all extended conditions 198 between the retracted condition 188 and the fully extended condition 190.

More specifically to release the wheel assemblies 186 the cable must be pulled to a first requisite tension. This first requisite tension is sufficient to release the wheel assemblies 186 from the retracted condition 188. The wheel assembly 182 as a whole then travels under the action of gravity to the fully extended condition 190. Once the cable 206, is released the limiter 204 is configured to selectively prevent movement back towards the retracted condition 188 but to allow movement when the actuator 202 is progressively actuated in an increasing manner from the locked extended condition 190. That is the limiter 204 is thus adapted to selectively allow movement from the extended conditions 198 towards the retracted position 188.

The limiter 204 comprises a series of stepped locking holes 208 having wall portions 210 therebetween. The wall portions 210 sequentially extend inwardly towards the suitcase 180 in sequential manner to allow progressive movement of a locking pin 212 sequentially past the wall portions 210 as the actuator 206 is progressively actuated. This is described in further detail below.

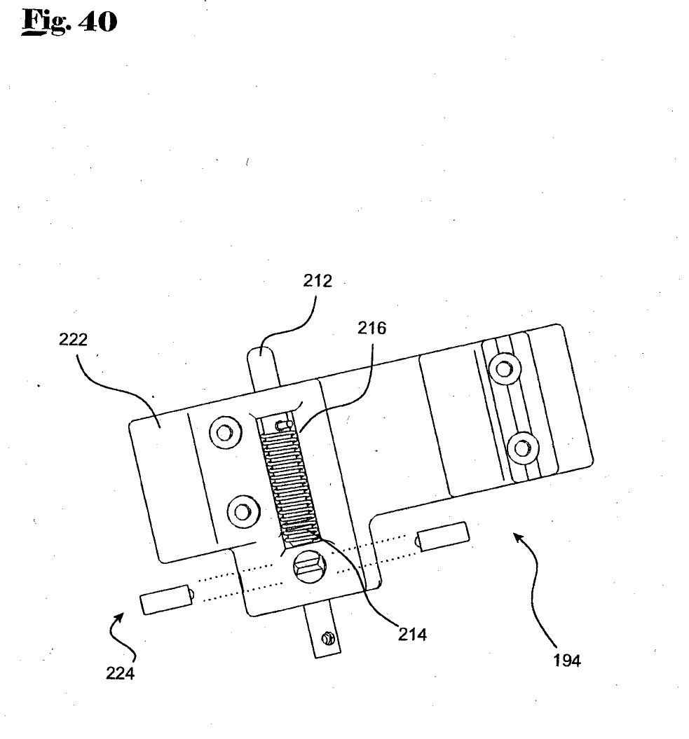

Referring to FIG. 40 there are two locking pins 212 each mounted in a mount 222 of the extension mechanism 194. The mounts 222 include biased detent pin arrangements 224 that engage with the grooves in the locking pins 212 to provide a positive indication to the user that the pins have been retracted to a position associated with an extended condition 190.

In operation a user pulls the cable 206 which acts against the bias of springs 214 in recesses 216 of the extension mechanism 194 to pull the locking pins 212 inwardly. Referring to FIG. 38, on extending towards the fully extended condition 190 the each locking pin 212 moves past a first abutment 218. As a second abutment 220 is of a lower height the locking pin 212 moves past the second abutment 220 as well to be positioned for release into a locking hole 225 corresponding with the fully extended condition 190.

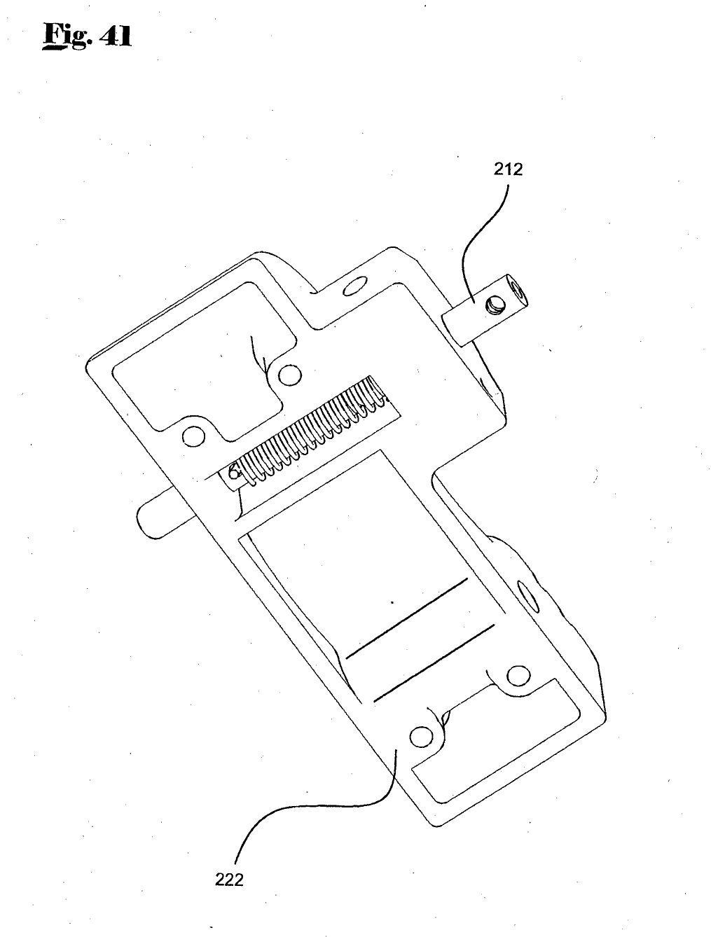

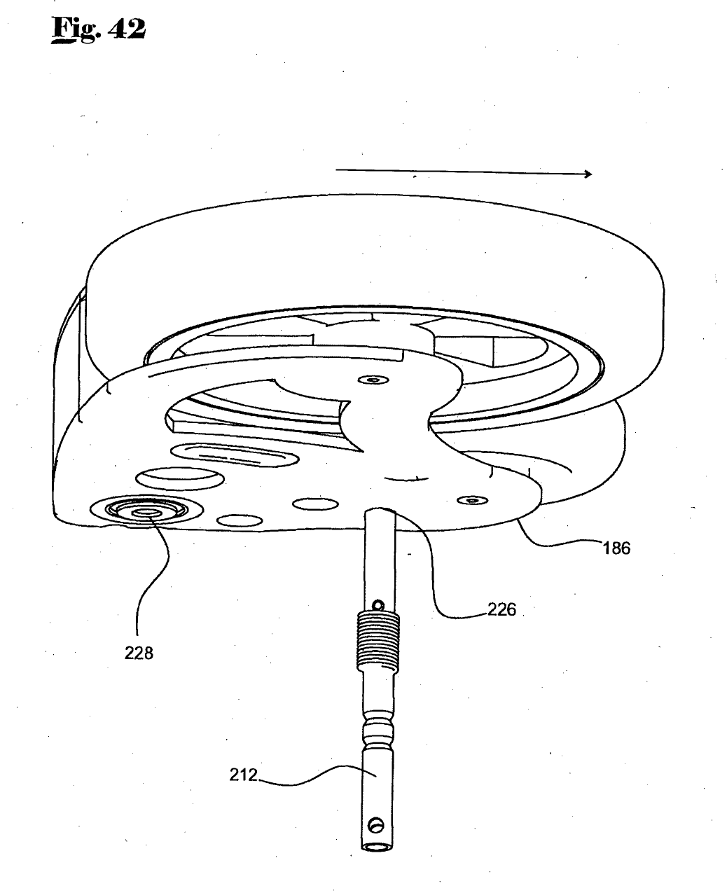

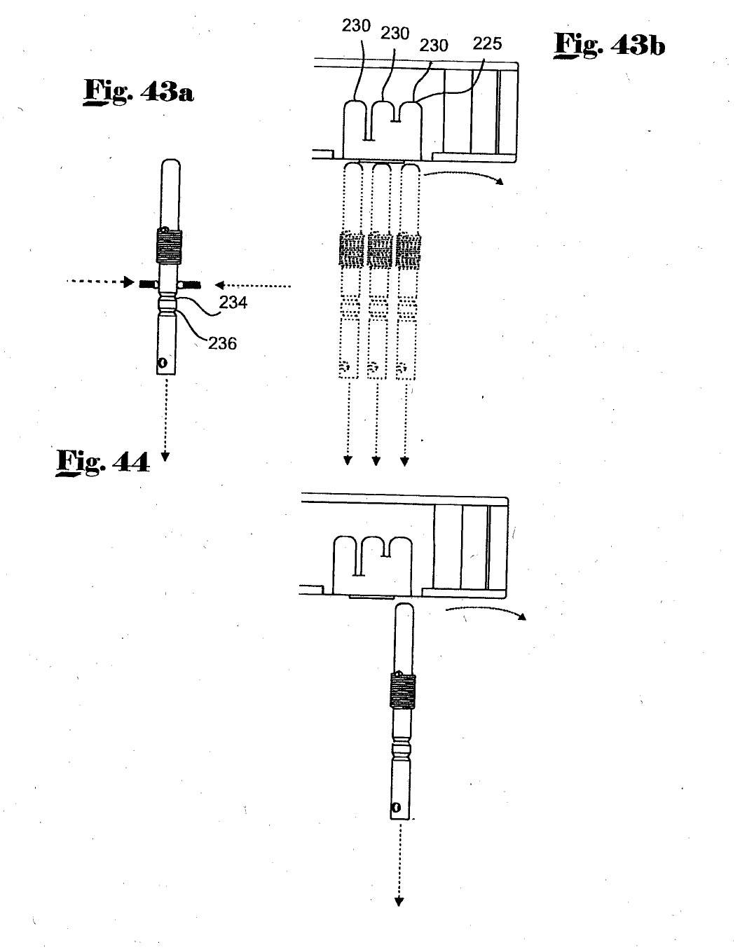

Referring to FIG. 42 the locking pin 212 is engaged in a first locking hole 226. Pulling the locking pin 212 releases the wheel assembly 186 which then falls downwardly about the pivot 228. The pin 212 to which tension has been applied then moves past each of the locking holes 230 as illustrated in FIG. 43. Notably when such a tension is applied the detent arrangement 224 is disposed above a first groove 234 and a second groove 236 of the locking pin 212.

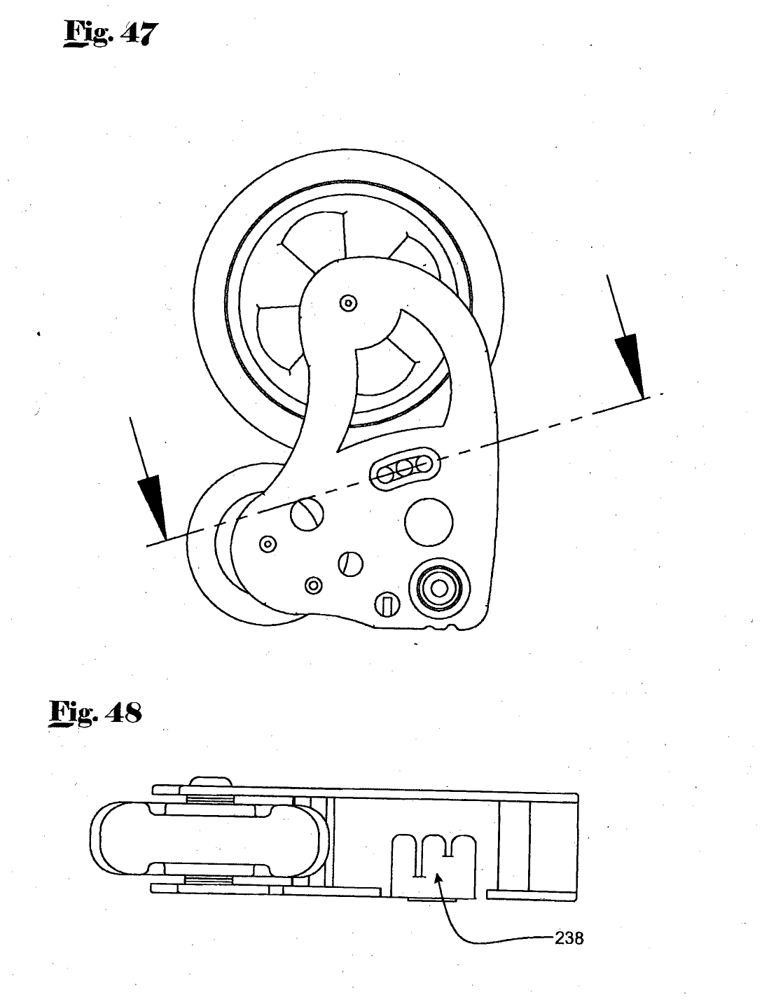

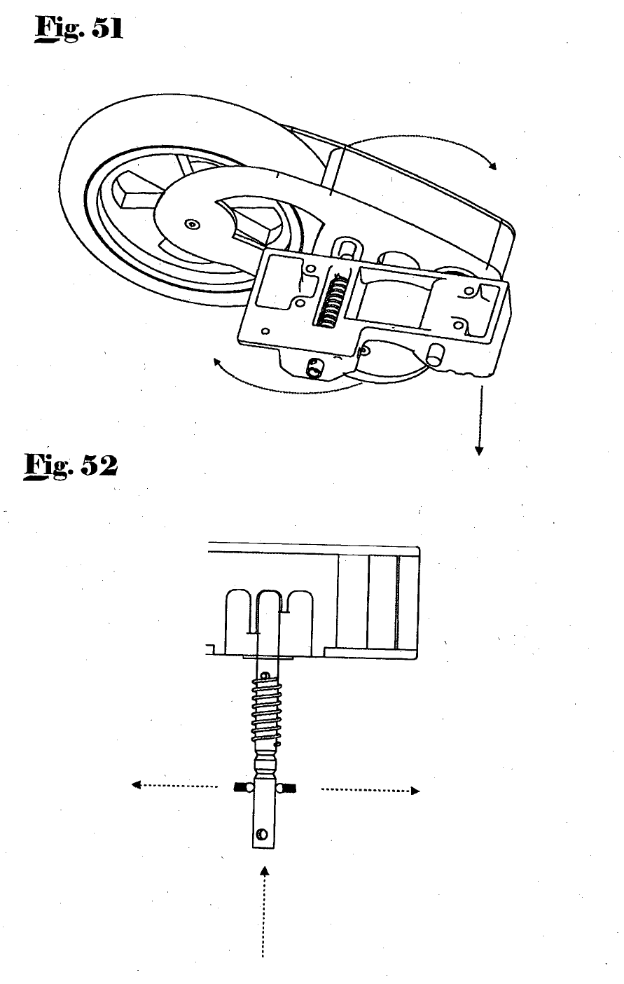

The locking pin 212 is then positioned above the locking hole 225 and is released as shown in FIGS. 44 to 46 to lock the wheel assembly 182 in the fully extended condition 190. FIGS. 47 and 48 illustrate the tiered structure 238 of the wall portions 210. In order to move from the fully extended position 190 the pin 212 must be lifted with a second degree of actuation notably less than the first degree of actuation. This is illustrated in FIG. 50.

More particularly at the point where the detent mates with the second groove 236 the pin 212 can be moved into the intermediate locking hole 240. When increased actuation is applied, at the point where the detent mates with the first groove 234, the pin can be moved into the intermediate locking hole 242. As would be apparent the wheel assembly 182 is moved towards the retracted position by the weight of the bag or by pushing downwardly.

The locking pins 212 are sized to be readily received into the locking holes 230. As shown the locking pins 212 extend fully into the wheel assembly (caster), so that the end of the pins rests on the bottom of the holes 230. The grooves in the pins match the tiers of the holes as described. More specifically, the ‘detent’ grooves in the pins ‘sequentially’ match the tiers of the ‘locking pin’ holes as described

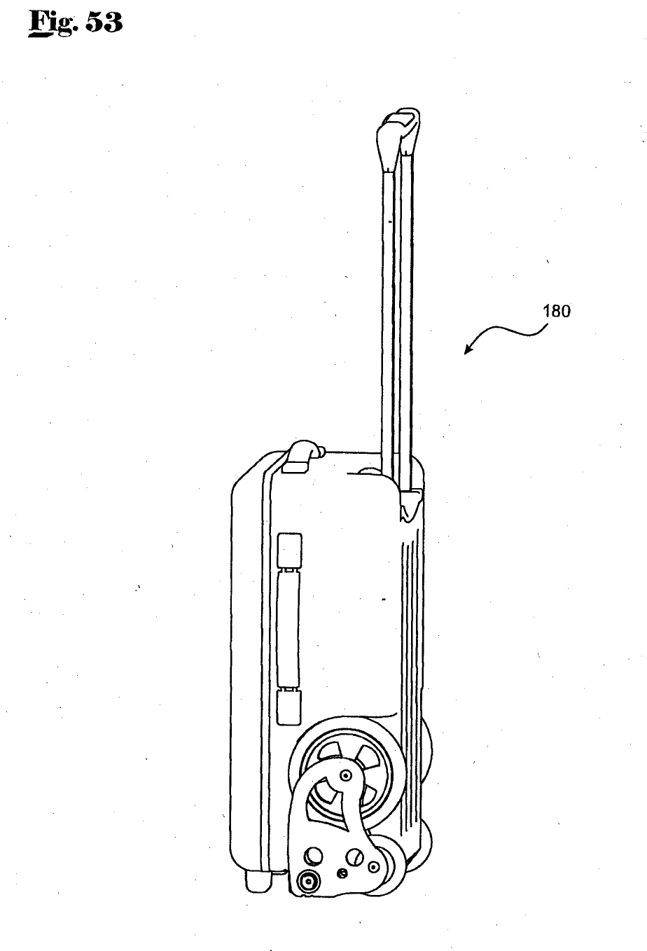

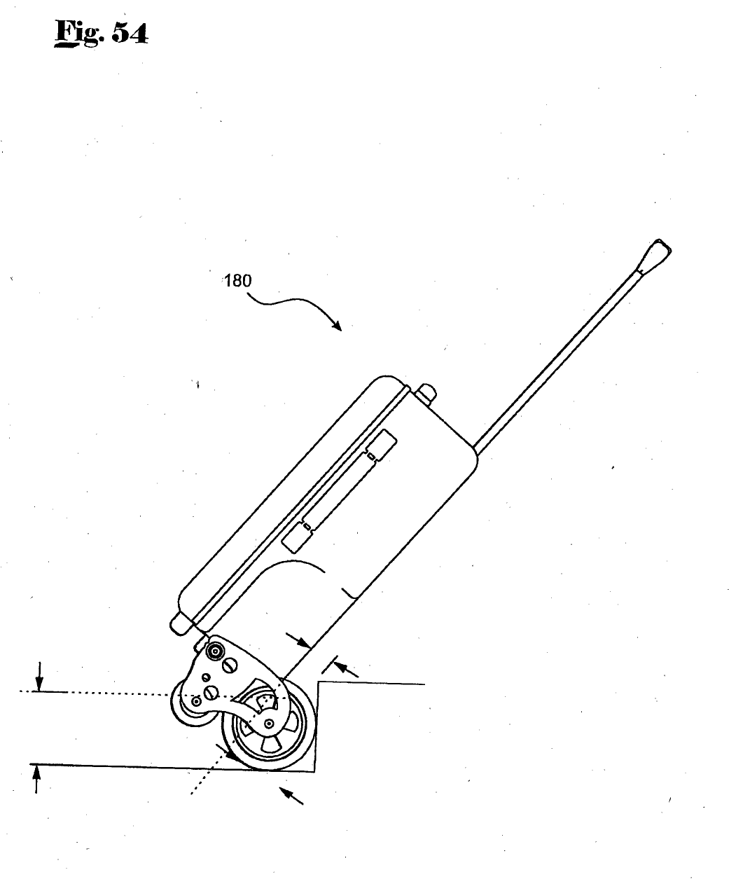

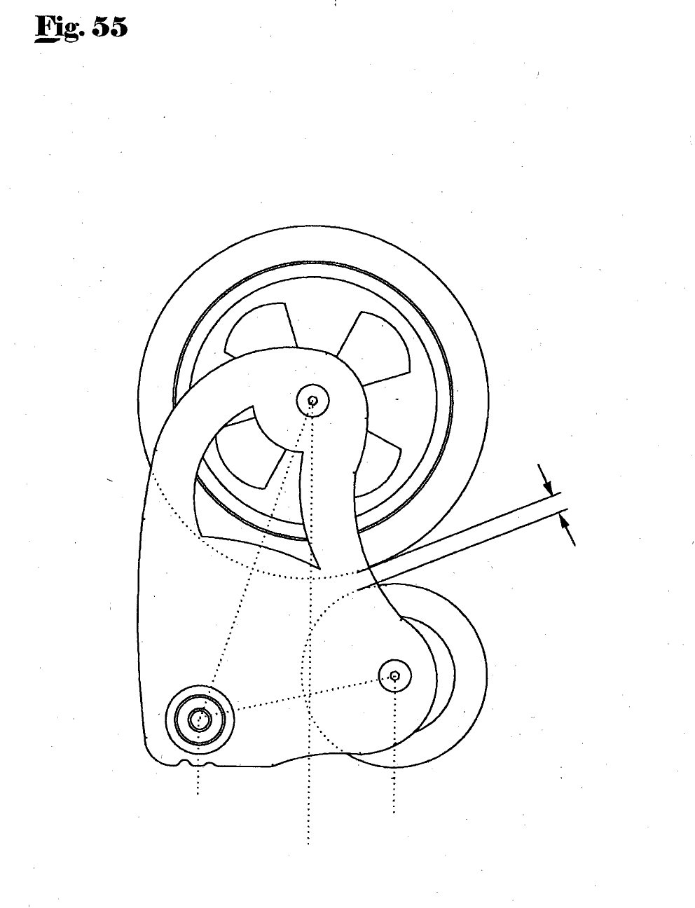

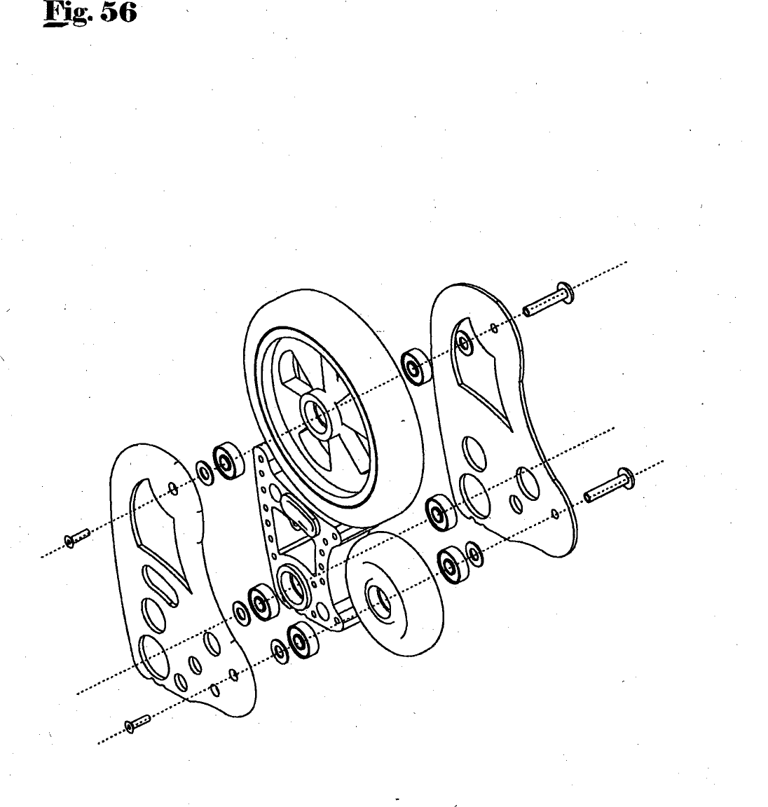

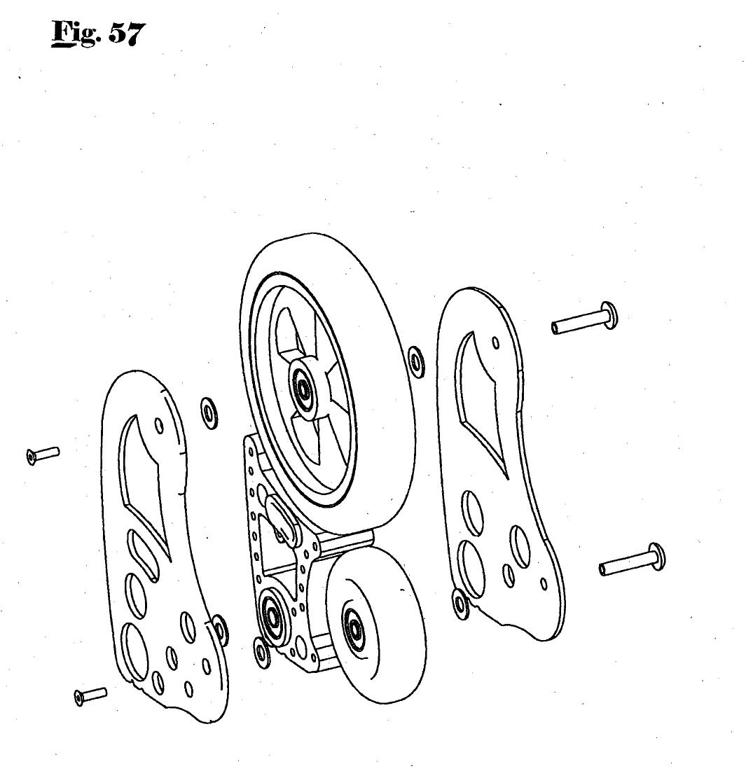

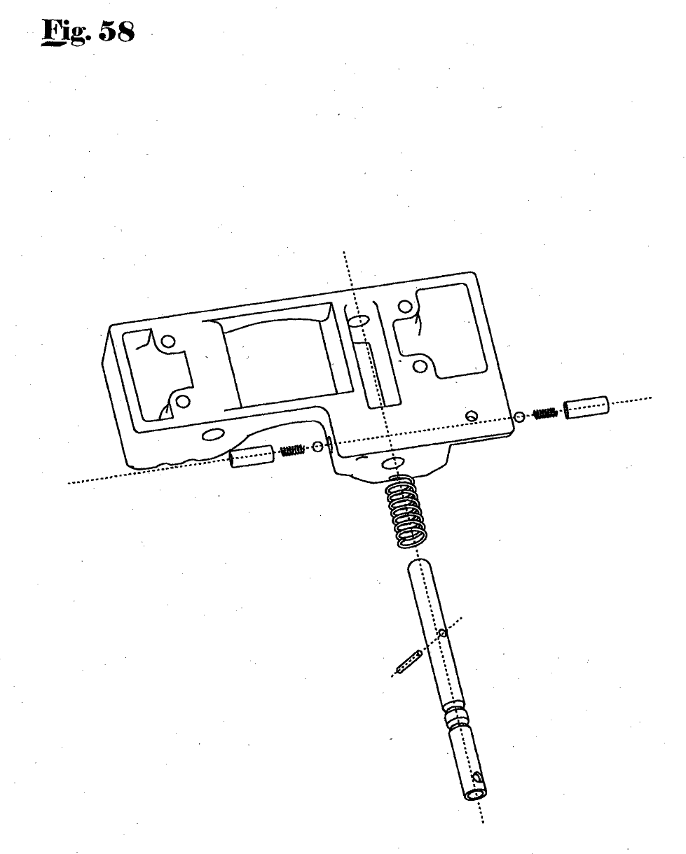

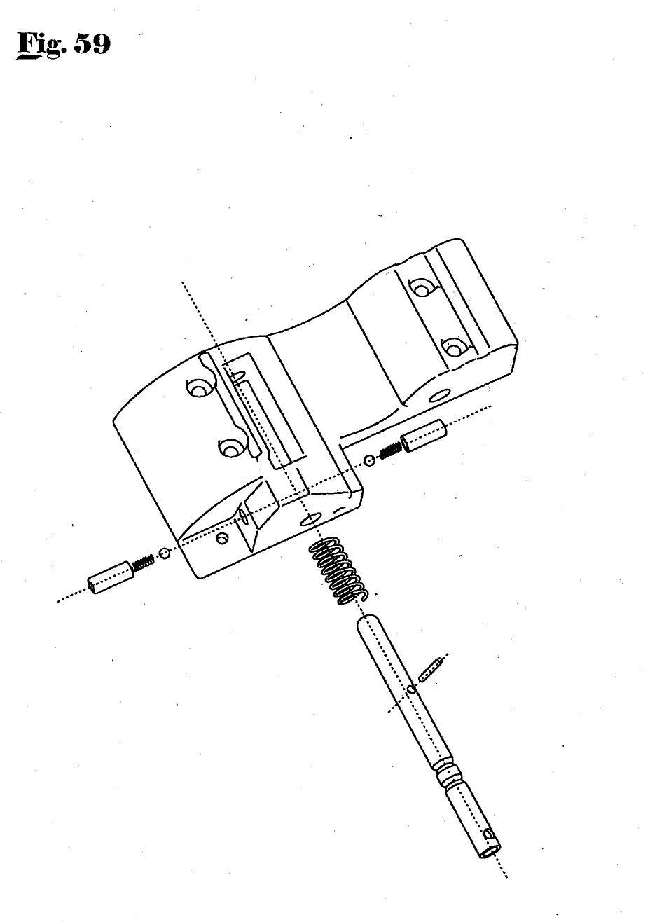

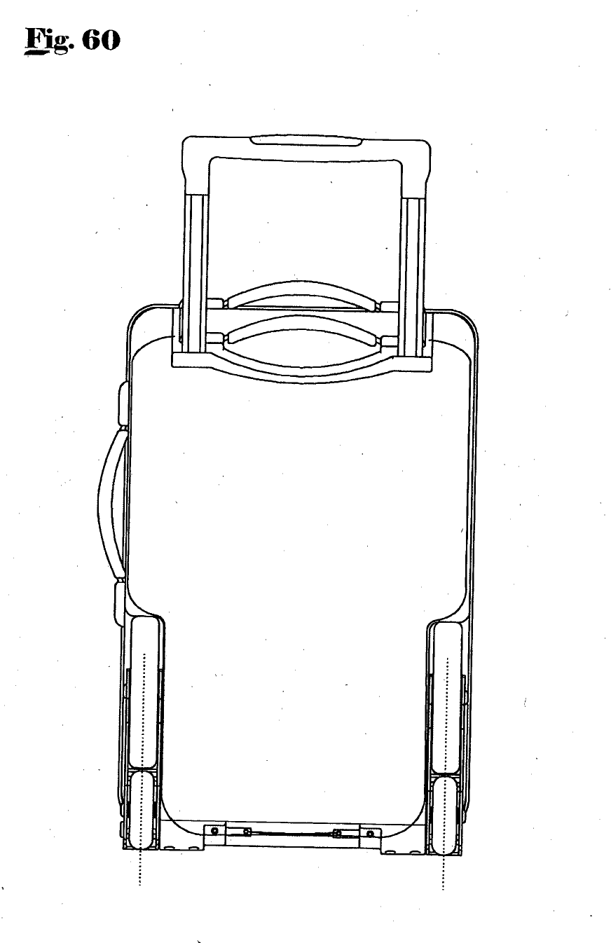

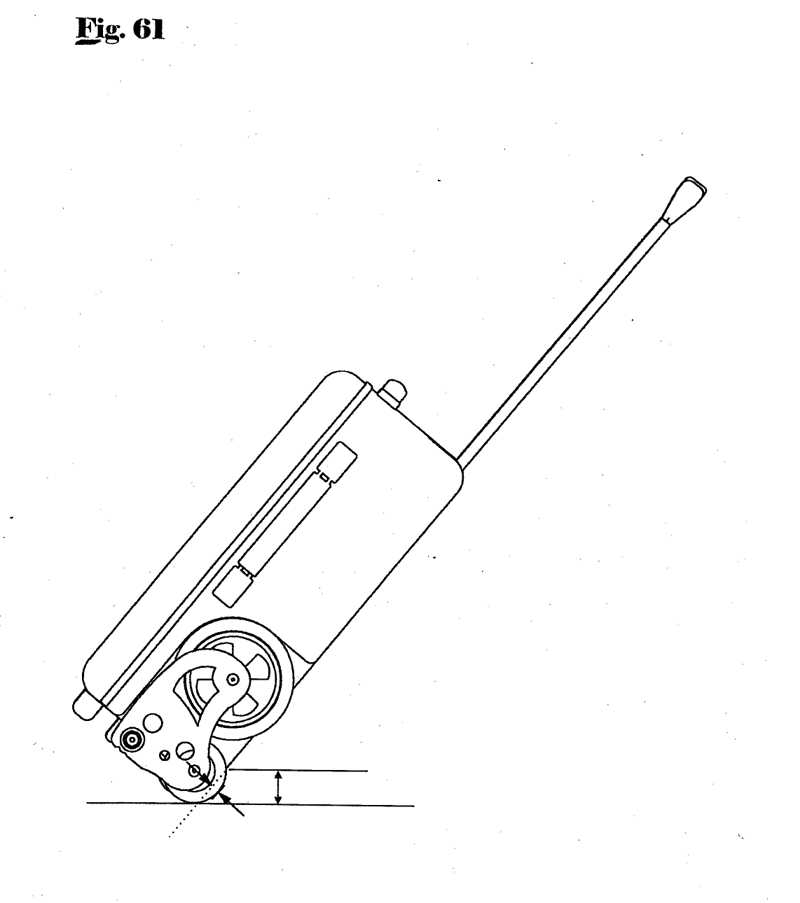

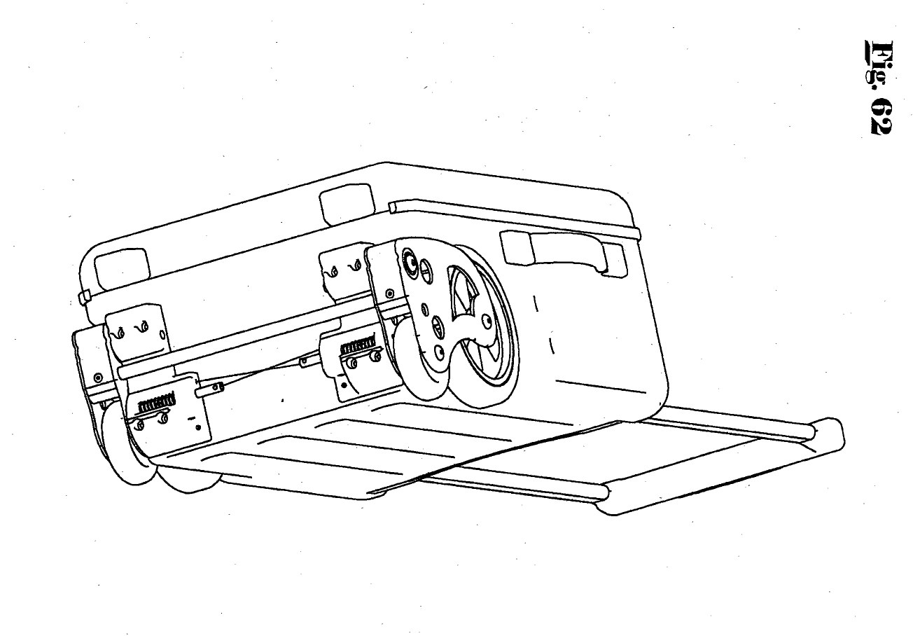

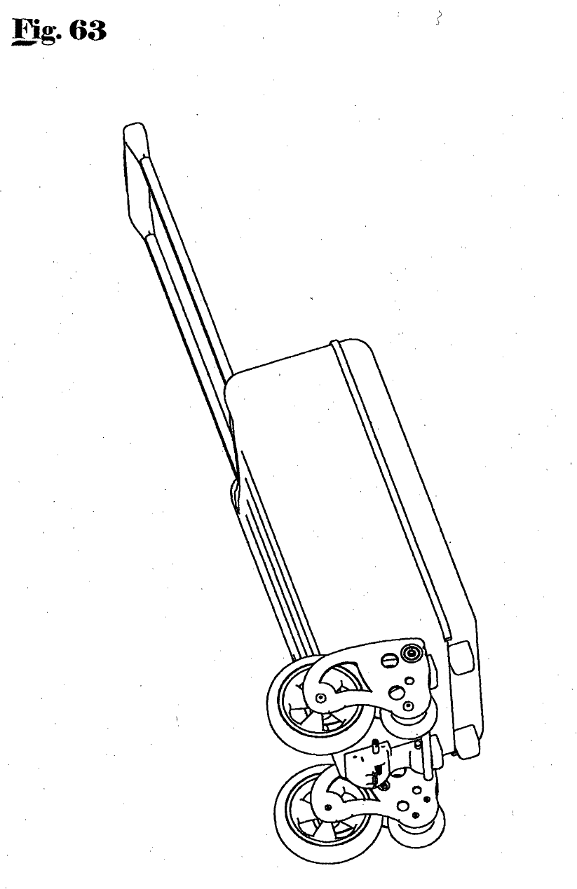

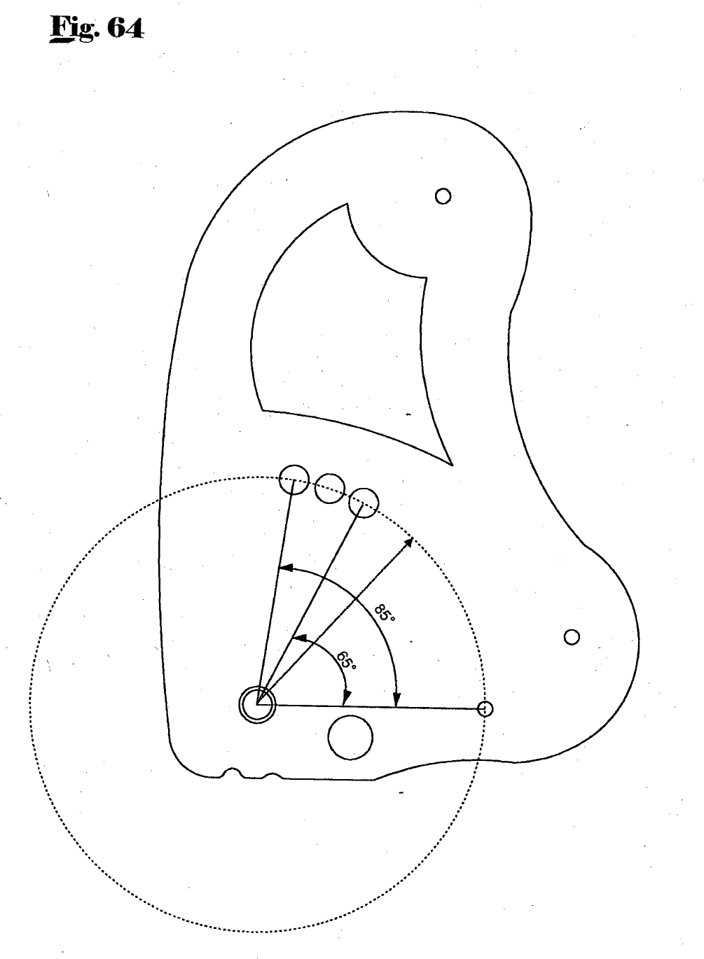

FIGS. 51 to 64 illustrate the suitcase 180 in more detail. Notably in this embodiment rotation from the retracted position to the fully extended position is over less than 90 degrees. The pivot of the larger wheel extends beyond the body of the case when the case is vertical. As shown in FIGS. 56 and 57 the bearings for the main axle are placed on the caster, as there is more space, and not on the axle mount.

In the embodiment the larger wheels are approximately twice the size of the smaller wheels. The distance between the pivot and the larger wheel is about the same size are the diameter of the larger wheel. It is possible for small suitcases that this could range between 12 to 18 cm. Of course other sizes are possible. The smaller wheel is substantially smaller than the larger wheel being approximately half the size of the larger wheel. The axis of the larger wheel extends below the axis of the pivot when in the fully extended position. Both the axis of the small wheels and the large wheels are disposed above the pivot when in the retracted position.

Preferred embodiments have been described with reference to Figures. In terms of the carrier 10, the carrier is considered to advantageously accommodate large wheels that provide advantageous rolling resistance. The large wheels are considered to make it easier to travel over uneven paths, cracked pavements, tracks, grass and even possibly snow. With the provision of relatively large wheels the chocking or abrupt stopping problem associated with small wheels encountering a surface irregularity on the ground of floor is largely overcome.

The ability to travel up and down steps in airports and other locations is considered to be particularly advantageous. The extended positions of the large wheels are considered to provide for greater foot clearance when pulling the carrier and high clearance in general for overcoming obstacles.

The provision of the replaceable wheel mounts (castors) each having a large and small wheel pair is considered to advantageously reduce the maximum comfortable drop distance when travelling ‘down’ a step. The provision of both large and small wheels allows the carrier to be pushed with ease. When the wheels are in the retracted configuration, the small wheel can still advantageously be used, to allow the carrier to be pulled like a normal suitcase. The retractable wheel system allows the centre of gravity to be readily adjusted. This can even allow for advantageous balancing when an extra bag is hung on front of the carrier. Changing the angle also is considered to allowing greater foot clearance when pushing the carrier. The retracted wheels fold into the width of the carrier due to the form of the frame. This does not increase the width of the carrier or create obstructing parts. To prevent any form of snagging an outer cover may be provided to cover the wheel mounts on the sides of the frame.

The retractable wheel system allows the wheel mounts (castors) to be interchanged with different sized wheel combinations for optimizing different needs. The system utilizes gravity for extending and retracting the wheel assembly. The rigid frame can act as a seat and protects contents while allowing for hard knocks and compression. The use of a handle extending across the top of the case for releasing the locking mechanism provides a wide grip allowing for advantageous hand placement and case control. The wide handle frame allows large open space at rear of case, and allows backpack straps to be added.

The robust nature of the retractable wheel system is considered also be advantageous in comparison to most wheel systems, retractable or otherwise. The limited number of components is also considered to be advantageous.

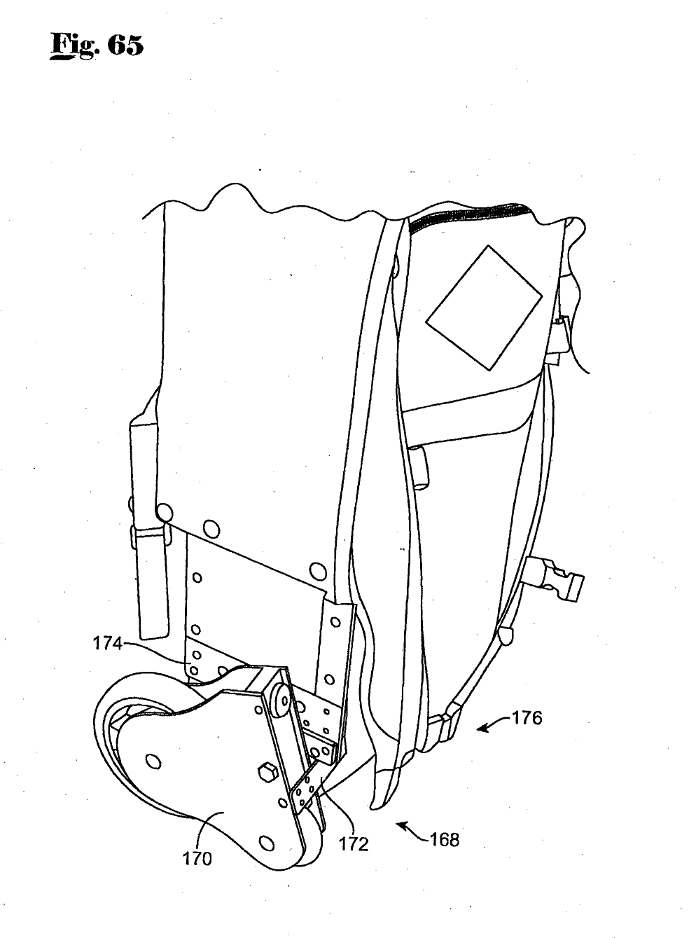

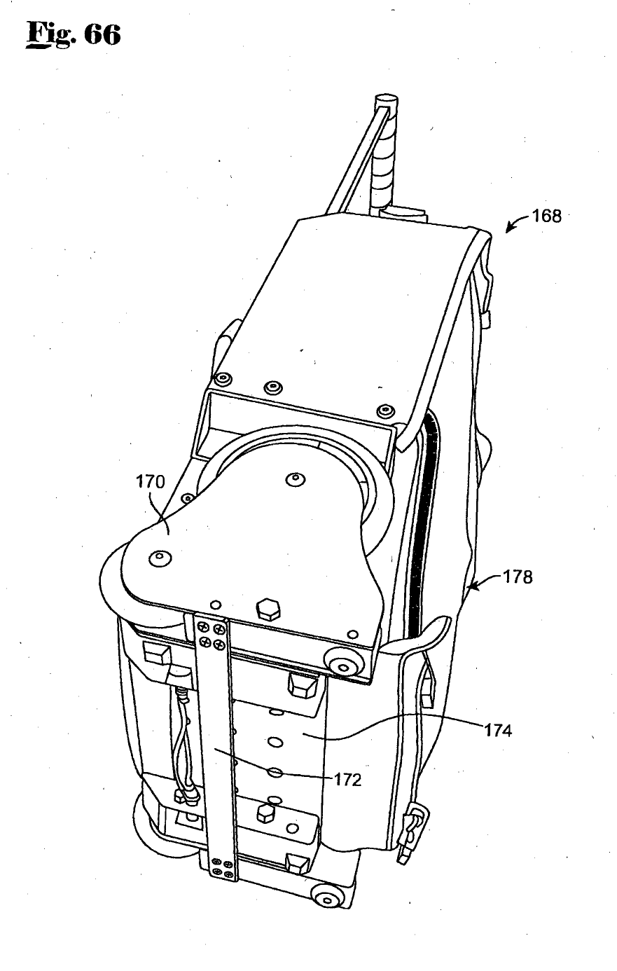

Another preferred embodiment in the form of a carrier 168 is shown in FIGS. 65 and 66. The carrier 168 includes two castors 170 connected by an elongate member. The elongate member is provided in the form of a bar 172 that ensures that the castors 170 move together and to stop outward flexing of the castors. The bar 172 is arranged to bear up against the bottom of the frame 174 of the carrier 168 when in a fully extended condition 176. In a fully retracted condition 178 the bar 172 is arranged to sit against the bottom of the frame 174 as shown.

In other embodiments the castors may fall independently without a connecting bar being present. The axles of opposite wheels could also be connected, but this is not preferred as having independent axles allows the carrier to hold a greater weight. Various locking mechanisms could be used with various releases. The components are robust and are designed to have a limited weight.

Preferred large wheel sizes may be at least 3, 4, 5, 6, or 7 inches or more. The large wheel 142 for example is about 8 inches in diameter. The large wheel 26 is about 5 inches in diameter. In one embodiment the applicant is envisaging sizes of: 155 mm large wheel and 80 mm small). In another embedment: 120 mm large and 100 mm small are envisaged.

It is to be recognised that various alterations and equivalent forms may be provided without departing from the spirit and scope of the present invention. This includes modifications within the scope of the appended claims along with all modifications, alternative constructions and equivalents. There is no intention to limit the present invention to the specific embodiments shown in the drawings. The present invention is to be construed beneficially to the applicant and the invention given its full scope.

In the present specification, the presence of particular features does not preclude the existence of further features. The words ‘comprising’, ‘including’ and ‘having’ are to be construed in an inclusive rather than an exclusive sense.

1. A carrier for a traveller, the carrier comprising: an extension mechanism and a wheel assembly; the wheel assembly including a number of large wheels and a number of secondary wheels of a substantially smaller diameter; the extension mechanism adapted to facilitate the rotation of the large and the secondary wheels when the wheel assembly is moved from a retracted condition to an extended condition wherein, in the retracted condition; the wheel assembly is able to be wheeled on the secondary wheels, with the large wheel disposed thereabove in a retracted position, and in the extended condition, the wheel assembly is able to be wheeled on both the secondary wheels and the large wheels or only on the large 10 wheels, as desired; the extended condition provides for rolling transport that is able to accommodate various obstacles and terrain.

2. A carrier as claimed in claim 1 wherein the wheel assembly includes a number of wheel mounts each having a large wheel and a secondary wheel; each wheel mount being rotatable so as to dispose the wheel system in the retracted or extended condition wherein in the retracted condition the wheel system can be wheeled on each secondary wheel and in an extended position the wheel system can be wheeled on both the secondary wheels and the large wheels or only on the large wheels, as desired.

3. (canceled)

4. A carrier as claimed in claimed in claim 3 wherein each large wheel is at least 3 inches in diameter and, when each large wheel is in the rolling position, the wheel is disposed so as to extend horizontally across and vertically down, when the carrier is in a substantially upright position to be pulled up a step by a person.

5. A carrier as claimed in claim 1 wherein, in the extended condition, the axis of each large wheel is disposed beneath the wheel system in comparison to when the wheel system is in the retracted condition.

6. (canceled)

7. (canceled)

8. (canceled)

9. A carrier as claimed in claim 1 wherein each large wheel and each secondary wheel are associated with a corresponding wheel pair; and in the extended position the wheel assembly can be pulled by the action of a person so as to roll on each large wheel with the associated secondary wheel being raised in the air.

10. A carrier as claimed in claim 1 wherein in the extended condition the wheel assembly can be pulled down stairs with the large wheels being positioned to rolls over the edge of a step of the stairs and the secondary wheels being positioned to move downwardly to contact the upper surface of the step to arrest the fall of the wheel assembly by contact with the upper surface of the step before each large wheel contacts the upper surface of the following step.

11. A carrier as claimed in claim 1 wherein there are two wheel pairs, each comprising a large wheel and a secondary wheel, in the wheel assembly that allow carrier to be stably rested in an upright condition and be pushed on the ground so as to roll on each of the wheels of the two wheel pairs.

12. (canceled)

13. A carrier as claimed in claim 1 wherein the wheel assembly provides a pivot about which the extension mechanism is adapted to facilitate the rotation of each of the large wheels and the secondary wheels in the wheel assembly.

14. A carrier as claimed in claim 9 wherein the extension mechanism is configured to facilitate the rotation of each large wheel and each secondary wheel by at least 60 degrees around the pivot when moving from the retracted to the extended condition.

15. A carrier as claimed in claim 9 wherein the extension mechanism is configured to facilitate the rotation of each large wheel and each secondary wheel by at least 70 degrees around the pivot when moving from the retracted to the extended condition.

16. A carrier as claimed in claim 9 wherein the extension mechanism is configured to facilitate the rotation of each large wheel and each secondary wheel by at least 80 degrees around the pivot when moving from the retracted to the extended condition.

17. A carrier as claimed in claim 9 wherein the extension mechanism is configured to facilitate the rotation of each large wheel and each secondary wheel by at least 90 degrees around the pivot when moving from the retracted to the extended condition.

18. A carrier as claimed in claim 9 wherein when the wheel assembly is in the retracted condition and upright, the axis of each large wheel is horizontally disposed between the pivot and the axis of the associated secondary wheel.

19. A carrier as claimed in claim 9 wherein the pivot is positioned such that when the wheel system is in the retracted condition and upright, the pivot is vertically disposed beneath the axis of the large wheel.

20. A carrier as claimed in claim 9 wherein the distance from the pivot to each large wheel is greater than the radius of each large wheel.

21. A carrier as claimed in claim 1 wherein the extended condition comprises a fully extended condition and the extension mechanism includes a locking mechanism for selectively locking the large wheels and the secondary wheels of the wheel assembly in any one of a series of extended conditions including the fully extended condition.

22. (canceled)

23. (canceled)

24. (canceled)

25. (canceled)

26. (canceled)

27. (canceled)

28. (canceled)

29. (canceled)

30. (canceled)

31. A carrier system as claimed in claim 1 wherein the diameter of each large wheel is at least 50 percent larger than the diameter of each secondary wheel.

32. A carrier system as claimed in claim 1 wherein the diameter of each large wheel is at least twice the diameter of each secondary wheel.

33. A carrier system as claimed in claim 1 wherein the diameter of each large wheel is at least 4 times the diameter of each secondary wheel.

34. (canceled)

35. (canceled)

36. A carrier system in claim 1 including a carrier frame wherein each large wheel is of a diameter at least 80% of the width of the sides of the carrier frame.

37. (canceled)

38. (canceled)

39. (canceled)

40. (canceled)

41. (canceled)

42. A carrier as claimed in claim 1 wherein the carrier includes a frame; and the secondary wheels and the large wheels are mounted on wheel mounts securing the wheels to the frame; the wheel mounts being rotated when moving the wheel 15 assembly between the retracted condition and the extended condition.

43. A wheel system for luggage or other carriers, the wheel system comprising: comprising: an extension mechanism and a wheel assembly; the wheel assembly including a number of lame wheels and a number of secondary wheels; the 5 extension mechanism adapted to facilitate the rotation of the large and the secondary wheels when the wheel assembly is moved from retracted condition to an extended condition; the wheel assembly can be wheeled on the secondary wheels, with the large wheel disposed thereabove in a retracted position, and in the extended condition, the wheel assembly can be wheeled on both the secondary wheels and 10 the large wheels or only on the large wheels, as desired; the extended condition providing for rolling transport that is able to accommodate various obstacles and terrain.
